(19) United States
(12) Patent Application Publication
(10) Pub. No.: US 2015/0022114 A1
(43) Pub. Date: Jan. 22, 2015

(54) TUBULAR LIGHT-EMITTING APPARATUS

(71) Applicant: SAMSUNG ELECTRONICS CO., LTD., Suwon-si (KR)

(72) Inventor: Chang-seob KIM, Seoul (KR)

(73) Assignee: SAMSUNG ELECTRONICS CO., LTD., Suwon-si (KR)

(21) Appl. No.: 14/334,075

(22) Filed: Jul. 17, 2014

(30) Foreign Application Priority Data
Jul. 17, 2013 (KR) 10-2013-0084376

(51) Int. Cl. H05B 33/08

(52) U.S. Cl. CPC H05B 33/0845
USPC 315/294

(57) ABSTRACT

Provided is a light-emitting apparatus and a method of operating the same. The light-emitting apparatus includes: a light-emitting module having a plurality of light-emitting diodes (LEDs); a cylindrical cover housing the light-emitting module, and transmitting light emitted from the plurality of LEDs; with a first socket at a first end of the cylindrical cover; a second socket at a second end of the cylindrical cover; and a dimmer controller mounted at the first socket so as to adjust an intensity of the light emitted from the plurality of LEDs. The light-emitting apparatus may adjust an intensity of light without a system change or equipment work.

### CROSS-REFERENCE TO RELATED APPLICATION

This application claims priority from Korean Patent Application No. 10-2013-0084376, filed on Jul. 17, 2013 in the Korean Intellectual Property Office, the disclosure of which is incorporated herein in its entirety by reference.

### BACKGROUND

Apparatuses and methods consistent with exemplary embodiments relate to a tubular-type light-emitting apparatus and a lighting system including the same, and more particularly, to a tubular-type light-emitting apparatus capable of adjusting its intensity of light without requiring a system change or repair work, and a lighting system including the tubular-type light-emitting apparatus.

Due to an increased focus on environmentalism, a light-emitting diode (LED) lighting apparatus having excellent energy efficiency is gaining popularity. As well as excellent energy efficiency, the LED lighting apparatus is further advantageous in saving energy because the LED lighting apparatus is able to easily adjust brightness. However, in order to apply a control system for controlling brightness to an existing lighting system, one must change the existing lighting system or separately perform equipment work.

### SUMMARY

Aspects of one or more exemplary embodiments provide a tubular-type light-emitting apparatus capable of adjusting its intensity of light without requiring a system change or equipment work.

Aspects of one or more exemplary embodiments also provide a lighting system capable of adjusting its intensity of light without requiring a system change or equipment work.

According to an aspect of an exemplary embodiment, there is provided a light-emitting apparatus including: a light-emitting module having a plurality of light-emitting diodes (LEDs); a cylindrical cover housing the light-emitting module, and transmitting light emitted from the plurality of LEDs; a first socket at a first end of the cylindrical cover; a second socket at a second end of the cylindrical cover; and a dimmer controller mounted at the first socket so as to adjust an intensity of the light emitted from the plurality of LEDs.

The dimmer controller may include: a dimmer switch; a signal generator which generates a signal according to a position of the dimmer switch; and a signal transmitter which transmits, to outside of the dimmer controller, the signal generated by the signal generator.

The dimmer controller may include a variable resistor.

The dimmer switch may be configured to rotate along an outer circumferential surface of the first socket.

The signal generator may generate a first signal in response to the dimmer switch being in a first position, and may generate a second signal in response to the dimmer switch being in a second position.

The dimmer switch may be configured to discretely rotate along the outer circumferential surface of the first socket.

The dimmer switch may be enabled to continuously rotate along the outer circumferential surface of the first socket.

The dimmer switch may be a push button at the outer circumferential surface of the first socket.

The intensity of the light emitted from the plurality of LEDs may vary according to a press of the push button.

The first socket may include an electrode terminal.

The first socket may include a dummy terminal and the second socket may include an electrode terminal.

The light-emitting apparatus may further include: a signal receiver which receives the signal transmitted from the signal transmitter; a signal controller which generates a control signal according to the signal received from the signal transmitter; and an LED driver which drives the light-emitting module according to the generated control signal.

According to an aspect of another exemplary embodiment, there is provided a lighting system including: a light-emitting apparatus; and a body having a first fixing part at a first end of the body and a second fixing part at a second end of the body, the first fixing part and the second fixing part configured to fix the light-emitting apparatus to the body, wherein the light-emitting apparatus includes a light-emitting module including a plurality of light-emitting diodes (LEDs); a cylindrical cover housing the light-emitting module, transmitting light emitted from the plurality of LEDs; a first socket at a first end of the cylindrical cover; a second socket at a second end of the cylindrical cover; and a dimmer controller mounted at the first socket so as to adjust an intensity of the light emitted from the plurality of LEDs.

The lighting system may further include a ballast in the body; the dimmer controller may include a dimmer switch, a signal generator configured to generate a signal according to a position of the dimmer switch, and a signal transmitter configured to transmit the signal generated by the signal generator; and the ballast may include a signal receiver configured to receive the signal transmitted from the signal transmitter, a signal controller configured to generate a control signal according to the signal that is received from the signal transmitter, and an LED driver configured to drive the light-emitting module according to the generated control signal.

The first socket at which the dimmer controller is mounted may be partly exposed between the cylindrical cover and the first fixing part, and the first socket and the second socket may be configured to adjust the intensity of the emitted light by rotating in a circumferential direction thereof.

According to an aspect of another exemplary embodiment, there is provided a method of operating a light-emitting apparatus, the method including: generating a signal according to a dimmer switch on a first socket at a first end of a cover, the cover housing a light-emitting diode (LED) of the light-emitting apparatus; adjusting an intensity of light emitted from the LED according to the generated signal.

### BRIEF DESCRIPTION OF THE DRAWINGS

Exemplary embodiments will be more clearly understood from the following detailed description taken in conjunction with the accompanying drawings in which:

FIG. 1A is a conceptual diagram of a tubular-type light-emitting apparatus, according to an exemplary embodiment;

FIG. 1B is a conceptual diagram of a tubular-type light-emitting apparatus according to another exemplary embodiment;

FIG. 2 is a perspective view of a cylindrical cover unit of each of the tubular-type light-emitting apparatuses, according to an exemplary embodiment;

FIG. 3 is a cross-sectional view of a structure of a circuit board of a light-emitting module included in a tubular-type light-emitting apparatus, according to an exemplary embodiment;

FIG. 4 is a cross-sectional view of a structure of a circuit board of a light-emitting module included in a tubular-type light-emitting apparatus, according to another exemplary embodiment;

FIG. 5 is a cross-sectional view of a structure of a circuit board of a light-emitting module included in a tubular-type light-emitting apparatus, according to another exemplary embodiment;

FIG. 6 is a cross-sectional view of a structure of a circuit board of a light-emitting module included in a tubular-type light-emitting apparatus, according to another exemplary embodiment;

FIG. 7 is a cross-sectional view of a structure of a circuit board of a light-emitting module included in a tubular-type light-emitting apparatus, according to another exemplary embodiment;

FIG. 8 is a cross-sectional view of a structure of a circuit board of a light-emitting module included in a tubular-type light-emitting apparatus, according to another exemplary embodiment;

FIG. 9 is a cross-sectional view of a structure of a metal sash to which a light-emitting module included in a tubular-type light-emitting apparatus is mounted, according to an exemplary embodiment;

FIG. 10 illustrates a color temperature spectrum related to light that is emitted from a light-emitting diode (LED) of a tubular-type light-emitting apparatus, according to an exemplary embodiment;

FIG. 11 illustrates a structure of a quantum dot that may be used in an LED of a tubular-type light-emitting apparatus, according to an exemplary embodiment;

FIG. 12 illustrates phosphor types according to application fields of a white light-emitting device using a blue-light LED in a tubular-type light-emitting apparatus, according to an exemplary embodiment;

FIG. 13 is a cross-sectional side view of an LED chip that may be used in a tubular-type light-emitting apparatus, according to an exemplary embodiment;

FIG. 14 is a cross-sectional side view of an LED chip that may be used in a tubular-type light-emitting apparatus, according to another exemplary embodiment;

FIG. 15 is a cross-sectional side view of an LED chip that may be used in a tubular-type light-emitting apparatus, according to another exemplary embodiment;

FIG. 16 illustrates a semiconductor light-emitting device that includes an LED chip mounted at a substrate and that may be used in a tubular-type light-emitting apparatus, according to an exemplary embodiment; and

FIG. 17 illustrates an LED package that may be used in a tubular-type light-emitting apparatus, according to an exemplary embodiment;

FIG. 18 is an exploded perspective view of a tubular-type light-emitting apparatus according to another exemplary embodiment;

FIG. 19 illustrates a tubular-type light-emitting apparatus that is applied to an L-tube assembly, according to another exemplary embodiment;

FIG. 20 is a cross-sectional view of primary parts of the L-tube assembly shown in FIG. 19;

FIG. 21 illustrates an example of light distribution at the L-tube assembly having the structure shown in FIG. 20;

FIG. 22 is a perspective view of a second socket of the tubular-type light-emitting apparatus, according to an exemplary embodiment;

FIG. 23 is a block diagram of a configuration of a dimmer controller in a tubular-type light-emitting apparatus, according to an exemplary embodiment;

FIG. 24 is a circuit diagram of a configuration of the dimmer controller of the tubular-type light-emitting apparatus, according to an exemplary embodiment;

FIG. 25 is a perspective view of a second socket of a tubular-type light-emitting apparatus, according to another exemplary embodiment;

FIG. 26 is a circuit diagram of a configuration of a dimmer controller of the tubular-type light-emitting apparatus, according to an exemplary embodiment;

FIG. 27A illustrates a lighting system including a tubular-type light-emitting apparatus, according to an exemplary embodiment;

FIG. 27B is a block diagram of a configuration of a dimmer controller capable of adjusting intensity of light of the lighting system, and an LED module controlled by the dimmer controller;

FIG. 28 is an exploded perspective view of a tubular-type light-emitting apparatus according to another embodiment;

FIG. 29 is a block diagram of a configuration of a dimmer controller for adjusting intensity of light of the tubular-type light-emitting apparatus; and

FIGS. 30A and 30B illustrate a home network to which a lighting system using a tubular-type light-emitting apparatus is applied, according to one or more exemplary embodiments.

### DETAILED DESCRIPTION OF EXEMPLARY EMBODIMENTS

Exemplary embodiments will now be described more fully with reference to the accompanying drawings, in which exemplary embodiments are shown. An exemplary embodiment may, however, be embodied in many different forms and should not be construed as being limited to exemplary embodiments set forth herein; rather, these exemplary embodiments are provided so that this disclosure will be thorough and complete, and will fully convey the inventive concept to those of ordinary skill in the art. In the drawings, similar reference numerals denote similar configuring elements, and the thicknesses of layers and regions are exaggerated for clarity.

While terms “first” and “second” are used to describe various components, it is obvious that the components are not limited to the terms “first” and “second”. The terms “first” and “second” are used only to distinguish between each component. For example, a first component may indicate a second component or a second component may indicate a first component without conflicting with the inventive concept.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify existence of a number, an operation, a component, and/or groups thereof, not excluding the existence of one or more other numbers, one or more other operations, one or more other components and/or groups thereof.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal.

As used herein, the term “and/or” includes any and all combinations of one or more of the associated listed items.

Expressions such as “at least one of,” when preceding a list of elements, modify the entire list of elements and do not modify the individual elements of the list.

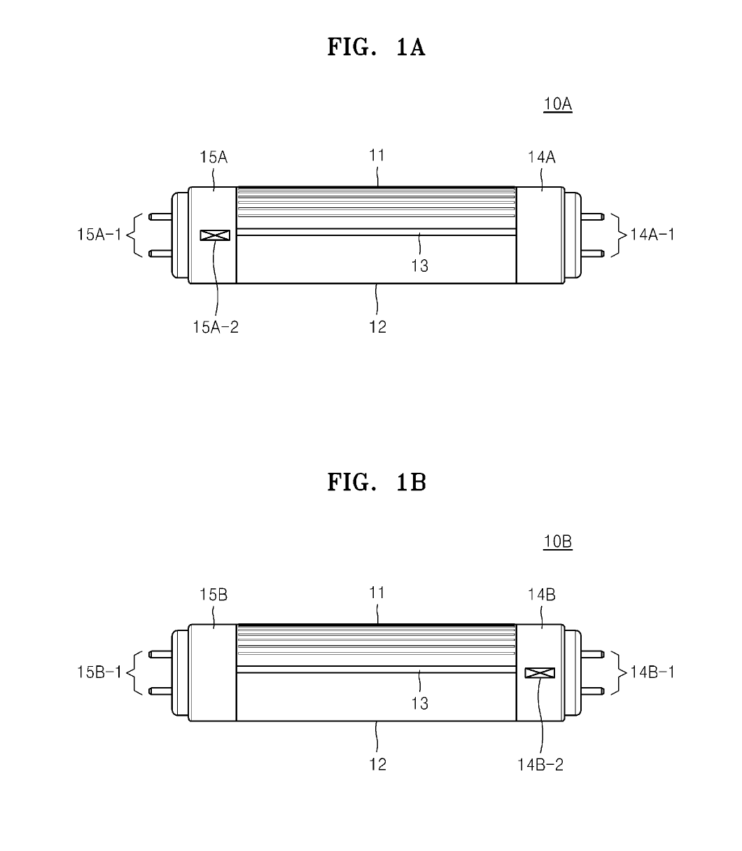

FIG. 1A is a conceptual diagram of a tubular-type light-emitting apparatus 10A according to an exemplary embodiment.

Referring to FIG. 1A, the tubular-type light-emitting apparatus 10A may include a heat dissipation member 11, a cover 12, a light-emitting module 13, a first socket 14A, and a second socket 15A.

The heat dissipation member 11 may be combined with the cover 12. The heat dissipation member 11 may include a material and a structure capable of efficiently dissipating and therefore removing heat that is generated in the light-emitting module 13.

The cover 12 has a structure that may be combined with the heat dissipation member 11. The cover 12 may include a transparent resin material for an optical use which may transmit light. For example, the transparent resin material may selectively include a material such as polymethyl methacrylate (PMMA), polycarbonate (PC), cyclo olefin polymer (COP), polyethylene terephthalate (PET), or acryl, or a material formed by coating a diffusion agent and/or a phosphor on an outer surface or an inner surface of at least one of the aforementioned materials. Also, the cover 12 may be formed by selectively using a transparent tube resin, a diffusion tube resin, a glass tube resin, or the like.

The heat dissipation member 11 and the cover 12 may be combined with each other to thereby form a cylindrical cover unit.

The light-emitting module 13 may be a module in which a plurality of light-emitting devices are arrayed. For example, the light-emitting module 13 may be provided with a plurality of light-emitting diodes (LEDs) disposed on a printed circuit board (PCB). The plurality of LEDs may be arranged in an array and may be driven by a driving circuit. Also, the light-emitting module 13 may be fixed to a supporting unit in the heat dissipation member 11 or the cover 12.

The first socket 14A and the second socket 15A indicate a pair of sockets that may be combined to ends of the cylindrical cover unit including the heat dissipation member 11 and the cover 12. For example, an electrode terminal 14A-1 may be disposed at the first socket 14A, and a dummy terminal 15A-1 may be disposed at the second socket 15A. For example, the dummy terminal 15A-1 may be electrically open or short-circuited to a ground.

The electrode terminal 14A-1 that is disposed at the first socket 14A may be electrically connected to the light-emitting module 13. In other words, a driving voltage that is applied to the light-emitting module 13 via the electrode terminal 14A-1 may be supplied from an external source.

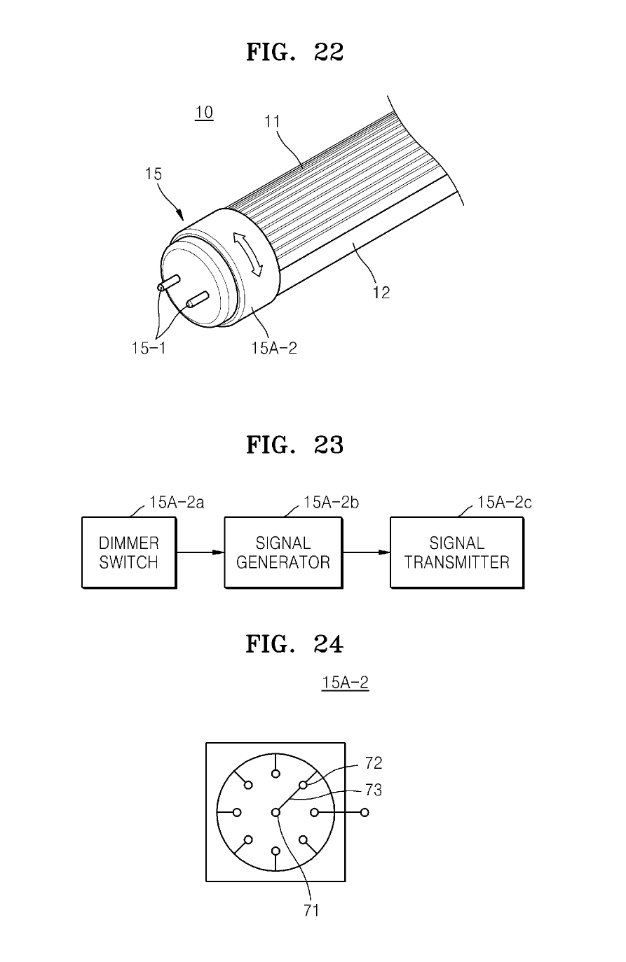

A dimmer controller 15A-2 may be embedded in the tubular-type light-emitting apparatus 10A. In particular, the dimmer controller 15A-2 may be embedded in the second socket 15A at which the dummy terminal 15A-1 is disposed. For example, the second socket 15A may have a socket structure that is integrated with the dimmer controller 15A-2. The structure of the second socket 15A and the dimmer controller 15A-2 that is embedded therein according to one or more exemplary embodiments will be described in detail below with reference to FIGS. 22 through 29.

FIG. 1B is a conceptual diagram of a tubular-type light-emitting apparatus 10B according to another exemplary embodiment.

Referring to FIG. 1B, the tubular-type light-emitting apparatus 10B may include the heat dissipation member 11, the cover 12, the light-emitting module 13, a first socket 14B, and a second socket 15B.

Since the heat dissipation member 11, the cover 12, and the light-emitting module 13 are respectively the same or similar elements as the heat dissipation member 11, the cover 12, and the light-emitting module 13 shown in FIG. 1A, detailed descriptions thereof are omitted here.

The first socket 14B and the second socket 15B indicate a pair of sockets that may be combined to ends of a cylindrical cover unit including the heat dissipation member 11 and the cover 12. For example, an electrode terminal 14B-1 may be disposed at the first socket 14B, and a dummy terminal 15B-1 may be disposed at the second socket 15B. The dummy terminal 15B-1 may be electrically open or short-circuited to a ground.

The electrode terminal 14B-1 that is disposed at the first socket 14B may be electrically connected to the light-emitting module 13. In other words, a driving voltage that is supplied to the light-emitting module 13 via the electrode terminal 14B-1 may be applied from an external source.

A dimmer controller 14B-2 may be embedded in the first socket 14B at which the electrode terminal 14B-1 is disposed. For example, the first socket 14B may be formed to have a socket structure that is integrated with the dimmer controller 14B-2. The structure of the first socket 14B and the dimmer controller 14B-2 that is embedded therein according to one or more exemplary embodiments will be described in detail with reference to FIGS. 22 through 29.

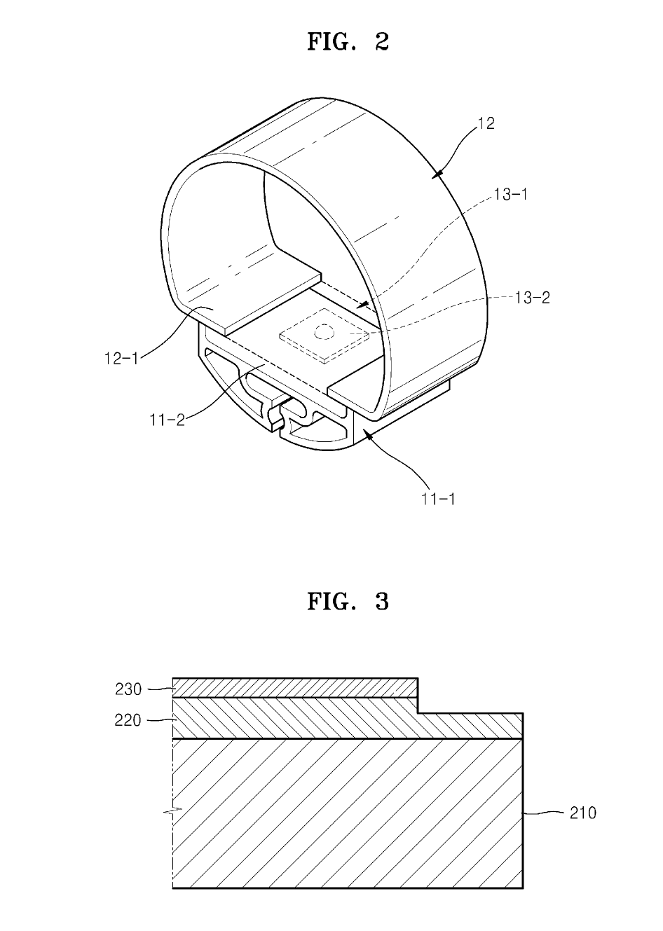

FIG. 2 is a perspective view of the cylindrical cover unit of each of the tubular-type light-emitting apparatuses 10A and 10B shown in FIGS. 1A and 1B, according to an exemplary embodiment.

As illustrated in FIG. 2, the cylindrical cover unit according to an exemplary embodiment includes a heat sink 11-1, a loading unit 11-2, and the cover 12. In further detail, the heat dissipation member 11 illustrated in FIGS. 1A and 1B may include the heat sink 11-1 and the loading unit 11-2. The light-emitting module 13 illustrated in FIGS. 1A and 1B may include a PCB 13-1 and a light-emitting device 13-2. For example, the light-emitting device 13-2 may include an LED.

The cover 12 may transmit light that is generated by the light-emitting device 13-2, and may surround the loading unit 11-2. The cover 12 may have a tubular shape. An opening may extend lengthwise at a side of the cover 12 in a longitudinal direction. That is, the cover 12 may be formed in the tubular shape having a ‘C’-shape cross-section, although it is understood that the ‘C’-shape is merely exemplary and one or more other exemplary embodiments may be applicable to various other shapes, for example, as desired or demanded by a particular application. The heat sink 11-1 may be disposed at the opening of the cover 12. Here, the loading unit 11-2 of the heat sink 11-1 may be disposed at the opening of the cover 12.

Here, the opening of the cover 12 may be smaller than the loading unit 11-2. For example, a cover end 12-1 that forms the opening of the cover 12 may interfere or overlap with the PCB 13-1 that is loaded onto the loading unit 11-2, so that the cover end 12-1 may prevent the PCB 13-1 from being undesirably unloaded from the loading unit 11-2. Thus, the PCB 13-1 may slide into the loading unit 11-2 via both open ends of the cover 12 and the heat sink 11-1. It is understood that one or more other exemplary embodiments are not limited to the above-described configuration to allow a PCB 13-1 to be inserted into the loading unit 11-2 while also preventing the PCB 13-1 from being undesirably unloaded. For example, according to another exemplary embodiment, an additional structural element may be connected to the cover 12 to interfere or overlap with the PCB 13-1 in order to prevent the PCB 13-1 from being undesirably unloaded, the cover end 12-1 may project over the PCB 13-1 and/or loading unit 11-2 on only one of opposing sides, etc.

Also, the first socket 14 and the second socket 15 (see FIGS. 1A and 1B) may be mounted, respectively, at the both ends of the cover 12, which are open in a longitudinal direction of the cover 12. The first socket 14 and the second socket 15 may prevent the PCB 13-1 from being undesirably unloaded from the loading unit 11-2 via either end of the cover 12 in the longitudinal direction. Thus, the PCB 13-1 is housed in a sealed space that is made by the heat sink 11-1, the cover 12, the first socket 14, and the second socket 15.

In the present exemplary embodiment, the cover 12 and the heat sink 11-1 may be integrally formed via an extruding method. That is, the cover 12 and the heat sink 11-1 may be formed of a material such as a heat dissipation resin that may be extruded, and when the cover 12 and the heat sink 11-1 are melted after being doubly extruded, the cover 12 and the heat sink 11-1 may be integrally bonded to each other.

The cover 12 may be formed of (i.e., include) a transparent or translucent extrudable material. For example, the cover 12 may be formed of a transparent or translucent material of which light transmittance is 50% so as to smoothly transmit light that is generated by the light-emitting device 13-2. For example, the cover 12 may be formed of a transparent or translucent plastic material such as polycarbonate or polycarbonate containing a diffuser.

The heat sink 11-1 may be formed of an extrudable material having a better heat dissipation property than a material of the cover 12. For example, the heat sink 11-1 may include a heat dissipation resin containing a high heat conductive filler so as to externally dissipate heat that is generated by the light-emitting device 13-2. For example, the heat sink 11-1 may be formed of a resin containing a filler capable of improving thermal conductivity, e.g., polycarbonate containing a high heat conductive filler. Examples of the filler to improve thermal conductivity may include a carbon filler, an alumina filler, a graphite filler, a ceramic filler, or the like.

As described above, when the cover 12 and the heat sink 11-1 are formed of different materials, the cover 12 and the heat sink 11-1 differ in a thermal expansion rate such that, when the cover 12 and the heat sink 11-1 are extruded, shapes of the cover 12 and the heat sink 11-1 may be undesirably deformed. Thus, at least one of the cover 12 and the heat sink 11-1 may further include a thermal expansion change material that changes a thermal expansion coefficient, and by doing so, properties of the cover 12 and the heat sink 11-1 may be changed to have equal or similar thermal expansion coefficients. The thermal expansion change material may include an inorganic filler or glass fiber capable of changing the thermal expansion coefficient. For example, the inorganic filler may include titanium dioxide (TiO₂), barium sulphate (BaSO₄), or silicon dioxide (SiO₂).

The PCB 13-1 onto which the light-emitting device 13-2 is mounted may be formed of a material for dissipating heat and reflecting light (i.e., having excellent heat dissipation and light reflection properties). For example, the PCB 13-1 may be an FR4-type PCB, may be formed of an organic resin material including epoxy, triazines, silicon, or polyimide, or other organic resin materials, or may be formed of a ceramic material including silicon nitride, aluminum nitride (AlN), aluminum oxide (Al₂O₃), or the like, or a material including metal and a metal compound, and may include a metal core PCB (MCPCB), or the like. The PCB 13-1 may be formed as a flexible PCB (FPCB) having flexibility so as to be deformed to match with a light diffusing unit having a curved shape.

The PCB 13-1 may be formed as a metal substrate, as shown in FIG. 3.

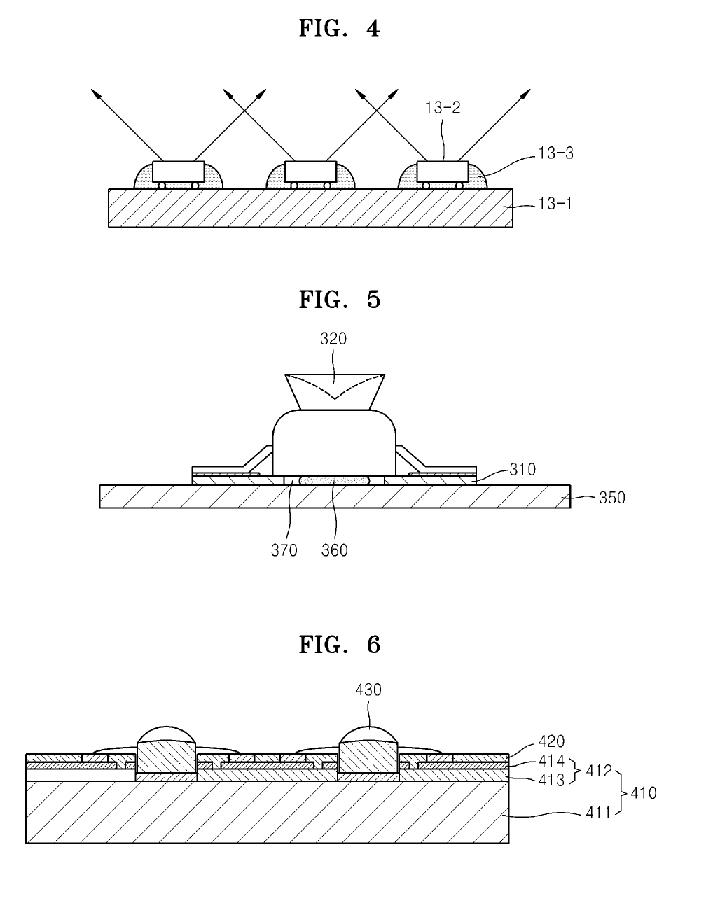

FIG. 3 is a cross-sectional view of a structure of a circuit board of a light-emitting module included in a tubular-type light-emitting apparatus, according to an exemplary embodiment. FIG. 4 is a cross-sectional view of a structure of a circuit board of a light-emitting module included in a tubular-type light-emitting apparatus, according to another exemplary embodiment. As illustrated in FIG. 3, the metal substrate includes an insulating layer 220 on a first metal layer 210, and a second metal layer 230 on the insulating layer 220. A stepped region to expose the insulating layer 220 is provided at one side end of the metal substrate.

The first metal layer 210 may be formed of a material for dissipating heat (i.e., having an excellent heat dissipation property), and may have a single-layer structure or a multi-layer structure. The insulating layer 220 may be formed of an insulating material including an inorganic material or an organic material. For example, the insulating layer 220 may be formed of an epoxy-based insulating resin including a metal powder such as an aluminum (Al) powder so as to improve thermal conductivity. In general, the second metal layer 230 may be formed of a copper (Cu) thin-film.

For example, as illustrated in FIG. 4, the PCB 13-1 may be a circuit board having a structure in which an LED chip is directly mounted on the PCB 13-1 or in which a package 13-2 having a chip is mounted on the PCB 13-1, and a waterproof agent 13-3 surrounds the package 13-2. For example, the PCB 13-1 may include a flexible substrate as shown in FIG. 5.

FIG. 5 is a cross-sectional view of a structure of a circuit board 310 of a light-emitting module included in a tubular-type light-emitting apparatus, according to another exemplary embodiment. As illustrated in FIG. 5, the flexible substrate may be provided as a slim-type substrate unit capable of decreasing a thickness and a weight of the photo sensor-integrated tubular light-emitting apparatus 10A, reducing manufacturing costs, and increasing a heat dissipation efficiency. The slim-type substrate unit includes a circuit board 310 having one or more through holes 370 formed therein, and LED chips or packages 320 that are coupled to the circuit board 320 via the one or more through holes 370, respectively. By using the flexible substrate as a substrate material of the slim-type substrate unit, the thickness and weight may be decreased so that slimness and light-weight may be achieved and manufacturing costs may be reduced. Also, since the LED chip or the package 320 is directly coupled to a supporting substrate 350 by using a heat dissipation adhesive 360, dissipation efficiency of heat that is generated in the LED chip or the package 320 may be increased.

Referring to FIG. 5, the flexible substrate may include a flexible PCB 310 in which at least one through hole 370 is formed, an LED chip or package 320 that is coupled onto the flexible PCB 310 via the at least one through hole 370, a supporting substrate 350 to which the flexible PCB 310 is mounted, and a heat dissipation adhesive 360 that is arranged in the at least one through hole 370 so as to couple a bottom surface of the LED chip or package 320 with a top surface of the supporting substrate 350. The bottom surface of the LED chip or package 320 may be a bottom surface of a chip package whose bottom surface of an LED chip is directly exposed, a bottom surface of a lead frame having a top surface to which a chip is mounted, or a metal block. For example, the PCB 13-1 may include a substrate as shown in FIG. 6.

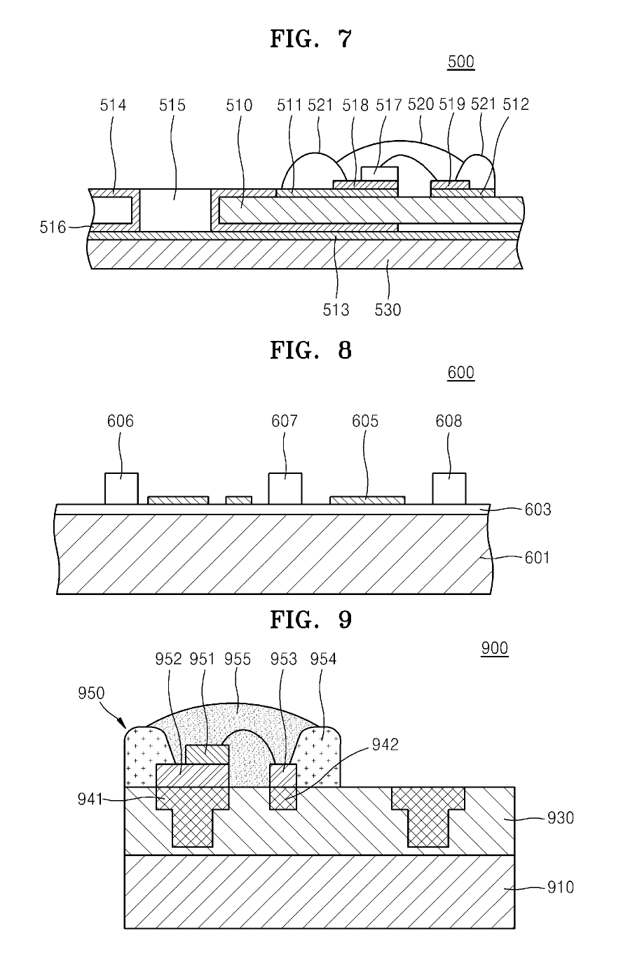

FIG. 6 is a cross-sectional view of a structure of a circuit board 410 of a light-emitting module included in a tubular-type light-emitting apparatus, according to another exemplary embodiment. As illustrated in FIG. 6, a circuit board 410 may have a structure in which a resin coating copper clad laminate (RCC) 412 that is formed of an insulating layer 413 and a circuit layer 414 (e.g., a copper thin film layer) that is stacked on the insulating layer 413 is stacked on a heat dissipation supporting substrate 411, and a protective layer 420 that is formed of a liquid photo solder resist (PSR) is stacked on the circuit layer 414. A portion of the RCC 412 is removed, so that a metal copper clad laminate (MCCL) having at least one groove to which an LED chip or package 430 is mounted is formed. In the circuit board 410 according to the present exemplary embodiment, an insulating layer at a lower region of the LED chip or package 430 at which a light source is positioned is omitted or removed, so that the light source 430 contacts the heat dissipation supporting substrate 411, and heat that is generated in the light source 430 is directly transferred to the heat dissipation supporting substrate 411, and thus a heat dissipation performance is improved. For example, the PCB 13-1 may include a circuit board 510 as shown in FIG. 7.

FIG. 7 is a cross-sectional view of a structure of a circuit board 510 of a light-emitting module 500 included in a tubular-type light-emitting apparatus, according to another exemplary embodiment. As illustrated in FIG. 7, the circuit board 510 is an insulation substrate and has a structure in which circuit patterns 511 and 512 formed of a copper laminate are on a top surface of the insulation substrate 510, and an insulation thin film layer 513 that is thinly coated as an insulation material may be on a bottom surface of the insulation substrate 510. Here, various coating methods such as a sputtering method or a spraying method may be used. Also, a top heat diffusion plate 514 and a bottom heat diffusion plate 516 may be on the top surface and the bottom surface of the circuit board 510, respectively, so as to dissipate heat that is generated in the LED module 500. In particular, the top heat diffusion plate 514 directly contacts the circuit pattern 511. For example, the insulation material that is used as the insulation thin film layer 513 has thermal conductivity that is significantly lower than that of a heat pad, but since the insulation thin film layer 513 has a very small thickness, the insulation thin film layer 513 may have a thermal resistance that is significantly lower than that of the heat pad. The heat that is generated in the LED module 500 may be transferred to the bottom heat diffusion plate 516 via the top heat diffusion plate 514 and then may be dissipated to a sash 530.

Two through holes 515 may be formed in the circuit board 510 and the top and bottom heat diffusion plates 514 and 516 so as to be vertical to the circuit board 510. The LED package may include an LED chip 517, LED electrodes 518 and 519, a plastic molding case 521, a lens 520, or the like. The circuit board 510 may have a circuit pattern that is formed by laminating a copper layer onto an FR4-core that is a ceramic or epoxy resin-based material and then by performing an etching process.

The LED module 500 may have a structure in which at least one of a red-light LED that emits red light, a green-light LED that emits green light, and a blue-light LED that emits blue light is included, and/or at least one type of a phosphor material may be coated on a top surface of an LED (e.g., the blue-light LED).

The phosphor material may be sprayed while including a particle powder that is mixed with a resin. The phosphor powder may be fired and thus may be formed in the form of a ceramic plate layer on the top surface of the blue-light LED. A size of the phosphor powder may be from 1 μm to 50 μm or, for example, from 5 μm to 20 μm. In a case of a nano phosphor, the phosphor may be a quantum dot having a size of from 1 nm to 500 nm or, for example, from 10 nm to 50 nm.

For example, the PCB 13-1 may include a metal substrate 600 as shown in FIG. 8.

FIG. 8 is a cross-sectional view of a structure of a circuit board of a light-emitting module included in a tubular-type light-emitting apparatus, according to another exemplary embodiment. As illustrated in FIG. 8, the metal substrate 600 may include a metal plate 601 that is formed of Al or an Al alloy, and an Al anodized layer 603 that is formed on a top surface of the metal plate 601. Heat generation devices 606, 607, and 608 such as LED chips may be mounted on the metal plate 601. The Al anodized layer 603 may insulate a wiring 605 from the metal plate 601.

The metal substrate 600 may be formed of Al or an Al alloy that is relatively less expensive. Alternatively, the metal substrate 600 may be formed of another material such as titanium or magnesium that may be anodized.

The Al anodized layer 603 that is obtained by anodizing Al has a relatively high heat transfer characteristic of about 10 through 30 W/mK. Thus, the metal substrate 600, including the Al anodized layer 603, may have a heat dissipation characteristic that is better than that of a polymer substrate-based PCB or an MCPCB according to the related art.

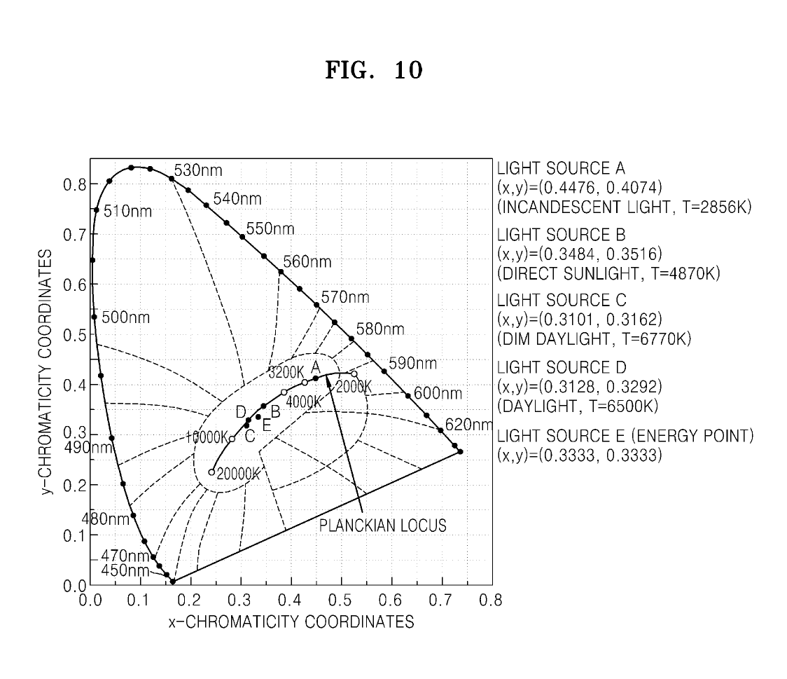

For example, the PCB 13-1 may include a circuit board 900 as shown in FIG. 9.

FIG. 9 is a cross-sectional view of a structure of a metal sash to which a light-emitting module included in a tubular-type light-emitting apparatus is mounted, according to an exemplary embodiment. As illustrated in FIG. 9, the circuit board 900 includes an insulation resin 930 that is coated on a metal substrate 910, circuit patterns 941 and 942 that are formed in the insulation resin 930, and an LED chip 951 that is mounted to be electrically connected with the circuit patterns 941 and 942. Here, the insulation resin 930, which may have a thickness that is equal to or less than 200 μm, may be laminated as a solid-state film on a metal substrate, or may be coated in a liquid state on the metal substrate by using spin coating or a molding method using a blade. A size of an insulation resin layer having an insulation circuit pattern may be equal to or less than a size of the metal substrate. Also, the circuit patterns 941 and 942 may be formed in a manner in which a metal material such as copper is filled in shapes of the circuit patterns 941 and 942 that are engraved in the insulation resin 930.

Referring to FIG. 9, an LED module 950 includes an LED chip 951, LED electrodes 952 and 953, a plastic molding case 954, and a lens 955.

In the present exemplary embodiment, the light-emitting device corresponds to a package product including the LED chip 951. However, it is understood that one or more other exemplary embodiments are not limited thereto. For example, according to another exemplary embodiment, the light-emitting device may be the LED chip 951 itself without the package. In this case, the LED chip 951 is a chip-on-board (COB) type LED chip that may be mounted on the circuit patterns 941 and 942 formed in the insulation resin 930 so that the LED chip 951 may directly achieve electrical connection with the metal substrate 910 via a flip chip bonding method or a wire bonding method, and a phosphor layer and/or a lens may be further formed on the LED chip 951.

A plurality of the light-emitting devices may be arrayed on the metal substrate 910. In this case, the plurality of the light-emitting devices may be homogeneous devices that generate light having the same wavelength. Alternatively, the plurality of the light-emitting devices may be heterogeneous devices that generate light having different wavelengths.

For example, the light-emitting devices may include at least one of a light-emitting device that is combination of a blue-light LED and one or more different types of phosphors that have a yellow, green, red, or orange color and that emits white light, and a light-emitting device that emits a purple color, a blue color, a green color, a red color, or infrared light. In this case, a lighting apparatus may be configured so that a Color Rendering Index (CRI) can be adjusted from a sodium lamp level (CRI=40) to a solar level (CRI=100) and also may generate a variety of white light in the color temperature range between from about 2,000K to about 20,000K, and when required or desired, the lighting apparatus may adjust a lighting color according to, for example, the ambient atmosphere or mood by generating visible light having a purple, blue, green, red, or orange color, or infrared light. Also, the lighting apparatus may generate light having a special wavelength capable of promoting a growth of plants.

White light that corresponds to a combination of the blue-light LED and the yellow, green, and red phosphors and/or green and red light-emitting devices may have at least two peak wavelengths and may be positioned at a line segment connecting (x, y) coordinates (0.4476, 0.4074), (0.3484, 0.3516), (0.3101, 0.3162), (0.3128, 0.3292), and (0.3333, 0.3333) of a CIE 1931 coordinate system. Alternatively, the white light may be positioned in a region that is surrounded by the line segment and a black body radiation spectrum. A color temperature of the white light may be between about 2,000K through about 20,000K. FIG. 10 illustrates a color temperature (i.e., a Planckian spectrum).

For example, phosphors that are used in an LED may have general formulas and colors as provided below:

oxide-based phosphors: yellow and green (Y, Lu, Se, La, Gd, Sm)3(Ga, Al)5O12:Ce, blue (Y, Lu, Se, La, Gd, Sm)3(Ga, Al)5O12:Ce

silicate-based phosphors: yellow and green (Ba, Sr)2SiO4:Eu, yellow and orange (Ba, Sr)3SiO5:Eu

nitride-based phosphors: green β-SiAlON:Eu, yellow (La, Gd, Lu, Y, Sc)3Si6N11:Ce, orange α-SiAlON:Eu, red (Sr, Ca)AlSiN3:Eu, (Sr, Ca)AlSi(ON)3:Eu, (Sr, Ca)2Si5N8:Eu, (Sr, Ca)2Si5(ON)8:Eu, (Sr, Ba)SiAl4N7:Eu

sulfide-based phosphors: red (Sr, Ca)S:Eu, (Y, Gd)2O2S:Eu, green SrGa2S4:Eu

fluoride-based phosphors: KSF-based red color K₂SiF₆:Mn⁴⁺

In general, the general formulas of the phosphors match with the stoichiometry, and each element may be substituted for another element in the same group of the periodic table. For example, Sr may be substituted for Ba, Ca, Mg, or the like of the alkaline-earth metal elements group II, and Y may be substituted for Tb, Lu, Sc, Gd, or the like of lanthanide-base elements. Also, Eu that is an activator may be substituted for Ce, Tb, Pr, Er, Yb, or the like according to a desired energy level, and the activator may be solely used or a sub-activator may be additionally used for a characteristic change.

As a substitute for the phosphors, materials such as a quantum dot or the like may be used, and in this case, the LED, the phosphors, and the quantum dot may be combined or the LED and the quantum dot may be used.

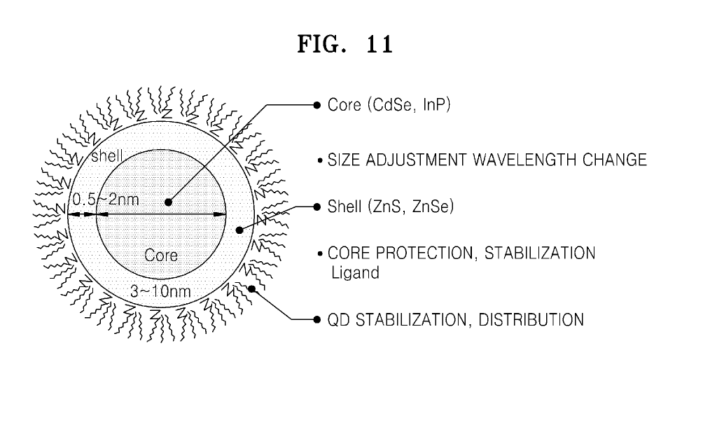

The quantum dot may have a structure of a core (e.g., from 3 nm to 10 nm) such as CdSe, InP, or the like, a shell (e.g., from 0.5 nm to 2 nm) such as ZnS, ZnSe, or the like, and a ligand for stabilization of the core-shell, and may realize various colors according to sizes. FIG. 11 illustrates an example of the structure of the quantum dot.

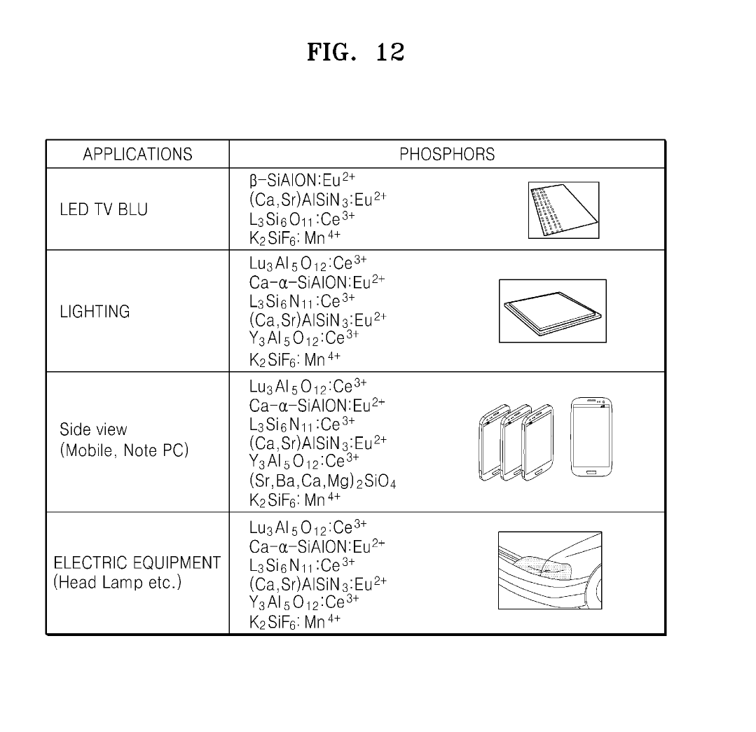

FIG. 12 illustrates phosphor types according to application fields of a white light-emitting device using a blue-light LED (e.g., from 440 nm to 460 nm).

Phosphors or quantum dots may be sprayed on an LED chip or a light-emitting device, may be used as a covering in the form of a thin-film, or may be attached in the form of a film-sheet or a ceramic phosphor sheet.

The phosphors or the quantum dots may be sprayed by using a dispensing method, a spray coating method, or the like, and in this regard, the dispensing method includes a pneumatic method and a mechanical method such as a screw, a linear type, or the like. A jetting method may allow a dotting amount control via a minute-amount discharge operation, and a color-coordinates control via the dotting amount control. A method of collectively spraying phosphors on a wafer level or a substrate of the light-emitting device may facilitate a control of productivity and a thickness of the light-emitting device.

The method of covering the phosphors or the quantum dots in the form of a thin-film on the light-emitting device or the LED chip may be performed by using an electrophoretic deposition method, a screen printing method, or a phosphor molding method, and any of the aforementioned methods may be used according to whether side surfaces of the LED chip are to be covered.

In order to control an efficiency of a long-wavelength light-emitting phosphor that re-absorbs light that is emitted at a short-wavelength and that is from among at least two types of phosphors having different emission wavelengths, the at least two types of phosphors having different emission wavelengths may be distinguished, and in order to minimize wavelength re-absorption and interference of the LED chip and the at least two types of phosphors, a DBR (ODR) layer may be arranged between layers.

In order to form a uniform coating layer, the phosphors may be arranged in the form of a film or a ceramic sheet and then may be attached on the LED chip or the light-emitting device.

In order to vary a light efficiency and a light distribution characteristic, a light conversion material may be positioned in a remote manner, and here, the light conversion material may be positioned together with a light-transmitting polymer material, a glass material, or the like according to durability and heat resistance of the light conversion material.

Since the phosphor spraying technology performs a major role in the determination of a light characteristic of an LED device, various techniques to control a thickness of a phosphor-coated layer, uniform distribution of the phosphors, or the like are being studied. Also, the quantum dot may be positioned at the LED chip or the light-emitting device in the same manner as the phosphors, and in this regard, the quantum dot may be positioned between glass materials or between light-transmitting polymer materials, thereby performing light conversion.

In order to protect the LED chip or the light-emitting device against an external environment or to improve an extraction efficiency of light that is externally emitted from the light-emitting device, a light-transmitting material as a filling material may be arranged on the LED chip or the light-emitting device.

Here, the light-transmitting material may be a transparent organic solvent including epoxy, silicone, a hybrid of epoxy and silicone, or the like, and may be used after being hardened via heating, light irradiation, a time-elapse, or the like.

With respect to silicone, polydimethyl siloxane is classified into a methyl-base, and polymethylphenyl siloxane is classified into a phenyl-base, and depending on the methyl-base and the phenyl-base, silicone differs in refractive index, water-permeation rate, light transmittance, lightfastness, and heat-resistance. Also, silicon differs in hardening time according to a cross linker and a catalyst, thereby affecting distribution of the phosphors.

The light extraction efficiency varies according to a refractive index of the filling material, and in order to minimize a difference between a refractive index of an outermost medium of emitted blue light of the LED chip and a refractive index of the blue light that is emitted to the outside air, at least two types of silicon having different refractive indexes may be sequentially stacked.

In general, the methyl-base has excellent heat-resistance, and variation due to a temperature increase is decreased in order of the phenyl-base, the hybrid, and epoxy. Silicone may be divided into a gel type, an elastomer type, and a resin type according to a hardness level.

The light-emitting device may further include a lens to radially guide light that is irradiated from a light source. In this regard, a pre-made lens may be attached on the LED chip or the light-emitting device, or a liquid organic solvent may be injected into a molding frame in which the LED chip or the light-emitting device is mounted and then may be hardened.

The lens may be directly attached on the filling material on the LED chip or may be separated from the filling material by bonding only an outer side of the light-emitting device and an outer side of the lens. The liquid organic solvent may be injected into the molding frame via injection molding, transfer molding, compression molding, or the like.

According to a shape (e.g., a concave shape, a convex shape, a concave-convex shape, a conical shape, a geometrical shape, or the like) of the lens, the light distribution characteristic of the light-emitting device may vary, and the shape of the lens may be changed according to requirements or desired parameters for the light efficiency and the light distribution characteristic.

The light-emitting device may be provided as the LED chip having one of various structures or may be provided as an LED package including the LED chips and having one of various forms. Hereinafter, various types of the LED chip and the LED package that may be employed in tubular-type light-emitting apparatuses according to one or more exemplary embodiments will be described in detail.

### LED Chip

### First Exemplary Embodiment

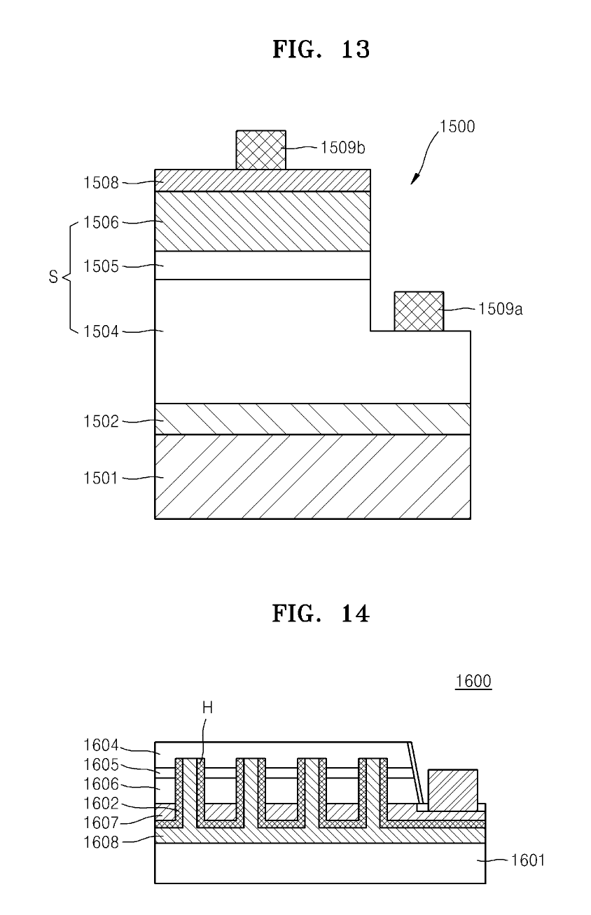

FIG. 13 is a cross-sectional side view of an LED chip 1500 that may be used in a tubular-type light-emitting apparatus, according to an exemplary embodiment.

As illustrated in FIG. 13, the LED chip 1500 includes an emission stack S that is formed on a substrate 1501. The emission stack S includes a first conductive semiconductor layer 1504, an active layer 1505, and a second conductive semiconductor layer 1506.

Also, the emission stack S includes an ohmic electrode layer 1508 on the second conductive semiconductor layer 1506, and a first electrode 1509a and a second electrode 1509b on top surfaces of the first conductive semiconductor layer 1504 and the ohmic contact layer 1508, respectively.

Throughout the specification, terms such as ‘upper’, ‘top surface’, ‘lower’, ‘bottom surface’, ‘side surface’, or the like are based on the drawings. Therefore, these terms may be changed according to a direction in which a device is actually disposed.

Hereinafter, elements of the LED chip 1500 according to an exemplary embodiment are described in detail.

The substrate 1501 may be formed of (i.e., include) an insulating substrate, a conductive substrate, or a semiconductor substrate. For example, the substrate 1501 may include sapphire, silicon carbide (SiC), silicon (Si), magnesium aluminate (MgAl₂O₄), magnesium oxide (MgO), lithium aluminate (LiAlO₂), lithium gallate (LiGaO₂), or gallium nitride (GaN). For an epitaxial growth of a GaN material, a GaN substrate that is a homogeneous substrate may, for example, be used.

An example of a heterogeneous substrate includes a sapphire substrate, a silicon carbide (SiC) substrate, or the like. When the heterogeneous substrate is used, a defect such as dislocation or the like is increased due to a difference between lattice constants of a substrate material and a thin-film material. Also, due to a difference between thermal expansion coefficients of the substrate material and the thin-film material, the substrate 1501 may be bent when a temperature is changed, and the bend causes a crack of a thin-film. The aforementioned problem may be decreased by using a buffer layer 1502 between the substrate 1501 and the emission stack S that includes a GaN material.

In order to improve an optical or electrical characteristic of the LED chip 1500 before or after an LED structure growth, the substrate 1501 may be completely or partly removed or may be patterned while a chip is manufactured.

For example, the sapphire substrate may be separated in a manner in which a laser is irradiated to an interface between the sapphire substrate and a semiconductor layer, and a silicon substrate or the SiC substrate may be removed by using a polishing method, an etching method, or the like.

When the substrate 1501 is removed, another supporting substrate may be used, and the supporting substrate may be bonded to the other side of an original growth substrate by using a reflective metal material or may be formed by inserting a reflection structure into an adhesion layer, so as to improve an optical efficiency of the LED chip 1500.

A patterning operation on a substrate may be performed by forming an uneven or sloped surface on a main side (e.g., a top surface or both surfaces) or side surfaces of the substrate before or after a growth of an LED structure. By doing so, a light extraction efficiency is improved. A size of a pattern may be selected in a range from 5 nm to 500 μm and, in order to improve the light extraction efficiency, a regular pattern or an irregular pattern may be implemented. In addition, a shape of the pattern may be a column, a cone, a hemisphere, a polygonal shape, or the like.

The sapphire substrate may include crystals having a hexagonal-rhombohedral (Hexa-Rhombo R3c) symmetry in which lattice constants of the crystal in c-axial and a-lateral directions are 13.001 and 4.758, respectively, and the crystal may have a C (0001) surface, an A (1120) surface, an R(1102) surface, or the like. In this case, the C (0001) surface easily facilitates the growth of a nitride thin-film, and is stable at a high temperature, so that the C (0001) surface may be used as a substrate for the growth of nitride.

The substrate may be formed as a Si substrate that is more appropriate for a large diameter and has a relatively low price, so that mass production may be improved. However, since the Si substrate having a (111) surface as a substrate surface has a lattice constant difference of about 17% with GaN, a technology is utilized to suppress occurrence of a defective crystal due to the lattice constant difference. In addition, a thermal expansion difference between silicon and GaN is about 56%, so that a technology is required to suppress wafer bend caused due to the thermal expansion difference. Due to the wafer bend, a GaN thin-film may have a crack, and it may be difficult to perform a process control such that dispersion of emission wavelength in a same wafer may be increased.

Since the Si substrate absorbs light that is generated in a GaN-based semiconductor, an external quantum efficiency of the light-emitting device 10 may deteriorate, so that the Si substrate may be omitted or removed, and a supporting substrate such as Si, germanium (Ge), silicon aluminum (SiAl), ceramic, or metal substrates including a reflective layer may be additionally formed and may be used.

When the GaN thin-film is grown on a heterogeneous substrate such as the Si substrate, a dislocation density may be increased due to a mismatch between lattice constants of a substrate material and a thin-film material, and the crack and the bend may occur due to the thermal expansion difference. In order to prevent the dislocation and the crack of the emission stack S, the buffer layer 1502 is disposed between the substrate 1501 and the emission stack S. The buffer layer 1502 decreases the dispersion of the emission wavelength of the wafer by adjusting a bending level of the substrate while the active layer is grown.

The buffer layer 1502 may be formed of AlₓIn_{y}Ga_{(1-x-y)}N (0≦x≦1, 0≦y≦1, 0≦x+y≦1), in particular, GaN, AlN, aluminum gallium nitride AlGaN, indium gallium nitride (InGaN), or InGaNAlN, and when utilized, the buffer layer 1502 may be formed of zirconium diboride (ZrB₂), hafnium diboride (HfB₂), zirconium nitride (ZrN), hafnium nitride (HfN), titanium nitride (TiN), or the like. Also, the buffer layer 1502 may be formed by combining a plurality of layers or by gradually varying composition of one of the aforementioned materials.

Since the Si substrate and the GaN thin-film have a large thermal expansion difference, when the GaN thin-film is grown on the Si substrate, the GaN thin-film is grown at a high temperature and then is cooled at a room temperature. At this time, a tensile stress may be applied to the GaN thin-film due to the thermal expansion difference between the Si substrate and the GaN thin-film, such that a crack in the GaN thin-film may easily occur. In order to prevent the crack, a compressive stress may be applied to the GaN thin-film while the GaN thin-film is grown, so that the tensile stress may be compensated.

Due to the lattice constant difference between the Si substrate and the GaN thin-film, the Si substrate may be defective. When the Si substrate is used, a buffer layer having a composite structure is used so as to simultaneously perform a defect control and a stress control to suppress a bend.

For example, AlN is first formed on the substrate 1501. In order to prevent reaction between Si and gallium (Ga), a material that does not contain Ga may be used. In this case, AlN or SiC may be used. AlN is grown by using aluminum (Al) and nitrogen (N) sources at a temperature between 400 and 1300 degrees. In one or more exemplary embodiments, an AlGaN intermediate layer may be inserted into a plurality of AlN layers so as to control a stress.

The emission stack S having a multi-layer structure of the group-III nitride semiconductor according to an exemplary embodiment will now be described in detail. The first and second conductive semiconductor layers 1504 and 1506 may be formed of semiconductors that are doped with n-type and p-type impurities, respectively, or vice versa. For example, each of the first and second conductive semiconductor layers 1504 and 1506 may be formed of, but are not limited to, the group-III nitride semiconductor, e.g., a material having a composition of AlₓIn_{y}Ga_{(1-x-y)}N (0≦x≦1, 0≦y≦1, 0≦x+y≦1). In another exemplary embodiment, each of the first and second conductive semiconductor layers 1504 and 1506 may be formed of a material including an AlGaInP-based semiconductor, an AlGaAs-based semiconductor, or the like.

Each of the first and second conductive semiconductor layers 1504 and 1506 may have a single-layer structure. However, in one or more other exemplary embodiments, each or one of the first and second conductive semiconductor layers 1504 and 1506 may have a multi-layer structure including a plurality of layers having different compositions or thicknesses. For example, each of the first and second conductive semiconductor layers 1504 and 1506 may have a carrier injection layer capable of improving an efficiency of electron and hole injection, and may also have a superlattice structure having various forms.

The first conductive semiconductor layer 1504 may further include a current diffusion layer that is adjacent to the active layer 1505. The current diffusion layer may have a structure in which a plurality of InₓAl_{y}Ga_{(1-x-y)}N layers having different compositions or different impurity ratios are repeatedly stacked, or may be partially formed of an insulation material layer.

The second conductive semiconductor layer 1506 may further include an electron block layer that is adjacent to the active layer 1505. The electron block layer may have a structure in which a plurality of InₓAl_{y}Ga_{(1-x-y)}N layers having different compositions are stacked or may have at least one layer formed of Al_{y}Ga_{(1-y)}N. Since the electron block layer has a bandgap larger than that of the active layer 1505, the electron block layer prevents electrons from entering to the second conductive semiconductor layer 1506 (that is a p-type).

The emission stack S may be formed by using a metalorganic chemical vapour deposition (MOCVD) apparatus. In more detail, the emission stack S may be formed in a manner in which a reaction gas such as an organic metal compound gas (e.g., trimethyl gallium (TMG), trimethyl aluminum (TMA), or the like) and a nitrogen containing gas (e.g., ammonia (NH3) or the like) are injected into a reaction container in which the substrate 1501 is arranged. Additionally, the substrate 1501 is maintained at a high temperature of about 900 to 1100 degrees, while a gallium-based compound semiconductor is grown on the substrate 1501 and, if desired, an impurity gas is injected, so that the gallium-based compound semiconductor is stacked as an undoped-type, an n-type, or a p-type. Si may be used as the n-type impurity. Zinc (Zn), cadmium (Cd), beryllium (Be), magnesium (Mg), calcium (Ca), barium (Ba), or the like may be used as the p-type impurity.

The active layer 1505 that is disposed between the first and second conductive semiconductor layers 1504 and 1506 may have a multi-quantum well (MQW) structure in which a quantum well layer and a quantum barrier layer are alternately stacked. For example, in a case of a nitride semiconductor, the active layer 1505 may have a GaN/InGaN structure. However, in another exemplary embodiment, the active layer 1505 may have a single-quantum well (SQW) structure.

The ohmic electrode layer 1508 may decrease an ohmic contact resistance by relatively increasing an impurity density, so that the ohmic electrode layer 1508 may decrease an operating voltage and may improve a device characteristic. The ohmic electrode layer 1508 may be formed of GaN, InGaN, zinc oxide (ZnO), or a graphene layer.

The first electrode 1509a or the second electrode 1509b may include a material such as silver (Ag), nickel (Ni), Al, rhodium (Rh), palladium (Pd), iridium (Ir), ruthenium (Ru), Mg, zinc (Zn), platinum (Pt), gold (Au), or the like, or may have a multi-layer structure including Ni/Ag, Zn/Ag, Ni/Al, Zn/Al, Pd/Ag, Pd/Al, Ir/Ag. Ir/Au, Pt/Ag, Pt/Al, Ni/Ag/Pt, or the like.

While the LED chip 1500 shown in FIG. 13 has a structure in which the first electrode 1509a, the second electrode 1509b, and a light extraction surface face the same side, the LED chip 1500 may have various structures in one or more other exemplary embodiments, such as a flip-chip structure in which the first electrode 1509a and the second electrode 1509b face the opposite side of the light extraction surface, a vertical structure in which the first electrode 1509a and the second electrode 1509b are formed on opposite surfaces, and a vertical and horizontal structure employing an electrode structure in which a plurality of vias are formed in a chip so as to increase an efficiency of current distribution and heat dissipation.

### LED Chip

### Second Exemplary Embodiment

FIG. 14 illustrates an LED chip 1600 according to another exemplary embodiment. For example, the LED chip 1600 illustrated in FIG. 14 has a structure useful for increasing an efficiency of current distribution and heat dissipation, when a large area light-emitting device chip for a high output for a lighting apparatus is manufactured.

As illustrated in FIG. 14, the LED chip 1600 includes a first conductive semiconductor layer 1604, an active layer 1605, a second conductive semiconductor layer 1606, a second electrode layer 1607, an insulating layer 1602, a first electrode layer 1608, and a substrate 1601. Here, in order to be electrically connected to the first conductive semiconductor layer 1604, the first electrode layer 1608 includes one or more contact holes H that are electrically insulated from the second conductive semiconductor layer 1606 and the active layer 1605 and that extend from a surface of the first electrode layer 1608 to a portion of the first conductive semiconductor layer 1604. According to one or more other exemplary embodiments, the first electrode layer 1608 may be omitted.

The contact hole H extends from an interface of the first electrode layer 1608 to an inner surface of the first conductive semiconductor layer 1604 via the second conductive semiconductor layer 1606 and the active layer 1605. The contact hole H extends to an interface between the active layer 1605 and the first conductive semiconductor layer 1604. For example, the contact hole H extends to the portion of the first conductive semiconductor layer 1604. Since the contact hole H operates to perform electrical connection and current distribution of the first conductive semiconductor layer 1604, the contact hole H achieves its purpose when the contact hole H contacts the first conductive semiconductor layer 1604. Accordingly, the contact hole H may not extend to an outer surface of the first conductive semiconductor layer 1604.

The second electrode layer 1607 that is on the second conductive semiconductor layer 1606 may be formed of a material selected from the group consisting of Ag, Ni, Al, Rh, Pd, Ir, Ru, Mg, Zn, Pt, and Au, in consideration of a light reflection function and an ohmic contact with the second conductive semiconductor layer 1606, and may be formed via a sputtering process or a deposition process.

The contact hole H has a shape that penetrates through the second electrode layer 1607, the second conductive semiconductor layer 1606, and the active layer 1605 so as to be connected with the first conductive semiconductor layer 1604. The contact hole H may be formed via an etching process using inductively coupled plasma (ICP)-reactive ion etching (RIE) or the like.

The insulating layer 1602 covers side walls of the contact hole H and a top surface of the second conductive semiconductor layer 1606. In this case, a portion of the first conductive semiconductor layer 1604 that corresponds to a bottom surface of the contact hole H may be exposed. The insulating layer 1602 may be formed by depositing an insulation material such as SiO₂, SiOₓN_{y}, SiₓN_{y}, or the like. The insulating layer 1602 may be deposited with a thickness range from about 0.01 μm to about 3 μm at a temperature of 500° C. or less via a chemical vapor deposition (CVD) process.

The second electrode layer 1607 that includes a conductive via formed by filling a conductive material is formed in the contact hole H. A plurality of the vias may be formed in a light-emitting device region. The number of vias and a contact area of the vias may be adjusted so that an area of the vias that contacts a first conductive-type semiconductor is within a range between about 1% and about 5% of an area of the light-emitting device region. A planar radius of the area of the vias that contacts the first conductive-type semiconductor may be within a range between about 5 μm and about 50 μm, and the number of vias may be between 1 and 50 for each light-emitting device region, according to an area of each light-emitting device region. Although the number of vias may vary according to the area of each light-emitting device region, the number of vias may be at least 3 according to an exemplary embodiment. A distance between the vias may correspond to a matrix array of rows and columns in the range between about 100 μm and about 500 μm, and in more detail, in the range between about 150 μm and about 450 μm. When the distance between the vias is less than about 100 μm, the number of vias is increased so that an emission area is relatively decreased such that an emission efficiency deteriorates. When the distance is greater than about 500 μm, a current spread may be difficult such that an emission efficiency may deteriorate. A depth of the contact hole H may vary according to a second semiconductor layer and an active layer and may be in the range between about 0.5 μm and about 5.0 μm.

Afterward, the substrate 1601 is formed on a surface of the first electrode layer 1608. In this structure, the substrate 1601 may be electrically connected to the first conductive semiconductor layer 1604 via the conductive via that contacts the first conductive semiconductor layer 1604.

The substrate 1601 may be formed of a material selected from the group consisting of Au, Ni, Al, copper (Cu), tungsten (W), Si, selenium (Se), gallium arsenide (GaAs), SiAl, Ge, SiC, AlN, Al₂O₃, GaN, and AlGaN, via a plating process, a sputtering process, a deposition process, or an adhesion process. However, a material and a forming method with respect to the substrate 1601 are not limited thereto in one or more other exemplary embodiments.

In order to decrease a contact resistance of the contact hole H, a total number of contact holes H, a shape of the contact hole H, a pitch of the contact hole H, a contact area of the contact hole H with respect to the first and second conductive semiconductor layers 1604 and 1606, or the like may be appropriately adjusted, and since the contact holes H are arrayed in various forms along rows and columns, a current flow may be improved.

### LED Chip

### Third Exemplary Embodiment

Since an LED lighting apparatus provides an improved heat dissipation characteristic, an LED chip having a small calorific value may be utilized in the LED lighting apparatus, in consideration of a total heat dissipation performance. An example of the LED chip may be an LED chip having a nano structure (hereinafter, referred to as a “nano LED chip”).

An example of the nano LED chip includes a core-shell type nano LED chip. The core-shell type nano LED chip generates a relatively small amount of heat due to its small combined density, and increases its emission area by using the nano structure so as to increase an emission efficiency. Also, the core-shell type nano LED chip may obtain a non-polar active layer, thereby preventing efficiency deterioration due to polarization, so that a drop characteristic may be improved.

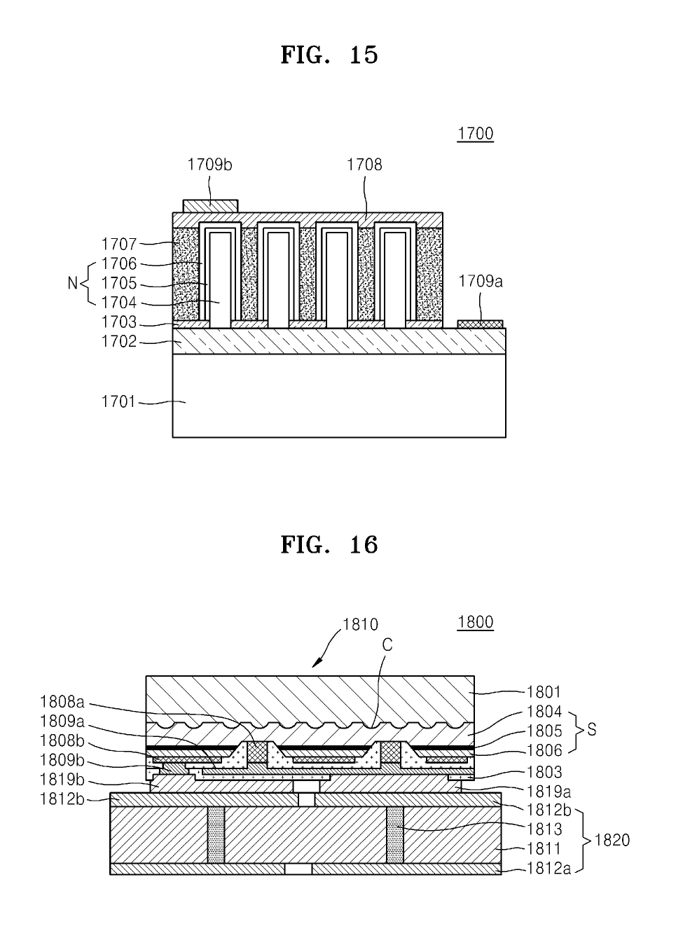

FIG. 15 illustrates a nano LED chip 1700 that may be applied to a tubular-type lighting apparatus, according to another exemplary embodiment.

As illustrated in FIG. 15, the nano LED chip 1700 includes a plurality of nano emission structures N that are formed on a substrate 1701. In the present exemplary embodiment, each nano emission structure N has a rod structure as a core-shell structure, although it is understood that one or more other exemplary embodiments are not limited thereto. For example, according to another exemplary embodiment, the nano emission structure N may have a different structure such as a pyramid structure.

The nano LED chip 1700 includes a base layer 1702 on the substrate 1701. The base layer 1702 may be a layer to provide a growth surface for the nano emission structures N and may be formed of a first conductive semiconductor. A mask layer 1703 having open areas for a growth of the nano emission structures N (in particular, a core) may be formed on the base layer 1702. The mask layer 1703 may be formed of a dielectric material such as silicon dioxide (SiO₂) or SiNₓ.

In the nano emission structure N, a first conductive nano core 1704 is formed by selectively growing the first conductive semiconductor by using the mask layer 1703 having open areas, and an active layer 1705 and a second conductive semiconductor layer 1706 are formed as a shell layer on a surface of the first conductive nano core 1704. By doing so, the nano emission structure N may have a core-shell structure in which the first conductive semiconductor is a nano core, and the active layer 1705 and the second conductive semiconductor layer 1706 that surround the nano core are the shell layer.

In the present exemplary embodiment, the nano LED chip 1700 includes a filling material 1707 that fills gaps between the nano emission structures N. The filling material 1707 may structurally stabilize the nano emission structures N. The filling material 1707 may include, but is not limited to, a transparent material such as SiO₂. An ohmic contact layer 1708 may be formed on the nano emission structure N so as to contact the second conductive semiconductor layer 1706. The nano LED chip 1700 includes first and second electrodes 1709a and 1709b that contact the base layer 1702, which is formed of the first conductive semiconductor, and the ohmic contact layer 1708, respectively.

By varying at least one of a diameter, a component, and a doping density of the nano emission structure N, light having at least two different wavelengths may be emitted from one device. By appropriately adjusting the light having the different wavelengths, white light may be realized in the one device without using a phosphor. In addition, by combining the one device with another LED chip or combining the one device with a wavelength conversion material such as a phosphor, light having desired various colors or white light having different color temperatures may be realized.

LED Chip

### Fourth Exemplary Embodiment

FIG. 16 illustrates a semiconductor light-emitting device 1800 that is a light source to be applied to a tubular-type light-emitting apparatus and that includes an LED chip 1810 mounted on a mounting substrate 1820, according to an exemplary embodiment.

The LED chip 1810 includes an emission stack S that is disposed on a surface of the substrate 1801, and first and second electrodes 1808a and 1808b that are disposed on the other surface of the substrate 1820 with respect to the emission stack S. Also, the LED chip 1810 includes an insulator 1803 (e.g., insulation unit) to cover the first and second electrodes 1808a and 1808b.

The first and second electrodes 1808a and 1808b may include first and second electrode pads 1819a and 1819b via first and second electric power connectors 1809a and 1809b.

The emission stack S may include a first conductive semiconductor layer 1804, an active layer 1805, and a second conductive semiconductor layer 1806 that are sequentially disposed on the substrate 1801. The first electrode 1808a may be provided as a conductive via that contacts the first conductive semiconductor layer 1804 by penetrating through the second conductive semiconductor layer 1806 and the active layer 1805. The second electrode 1808b may contact the second conductive semiconductor layer 1806.

A plurality of the vias may be formed in a light-emitting device region. The number of vias and a contact area of the vias may be adjusted so that an area of the vias that contact a first conductive-type semiconductor is within a range between about 1% and about 5% of an area of the light-emitting device region. A planar radius of the area of the vias that contacts the first conductive-type semiconductor may be within a range between about 5 μm and about 50 μm, and the number of vias may be between 1 and 50 vias for each light-emitting device region, according to an area of each light-emitting device region. Although the number of vias may vary according to the area of each light-emitting device region, the number of vias may be at least 3 according to an exemplary embodiment. A distance between the vias may correspond to a matrix array of rows and columns in the range between about 100 μm and about 500 μm, and in more detail, in the range between about 150 μm and about 450 μm. When the distance between the vias is less than about 100 μm, the number of vias is increased so that an emission area is relatively decreased such that an emission efficiency deteriorates. However, when the distance is greater than about 500 μm, a current spread may be difficult such that an emission efficiency may deteriorate. A depth of the contact hole H may vary according to a second semiconductor layer and an active layer and may be in the range between about 0.5 μm and about 5.0 μm.

A conductive ohmic material may be deposited on the emission stack S so that the first and second electrodes 1808a and 1808b are formed. The first and second electrodes 1808a and 1808b may be electrodes each including at least one material selected from the group consisting of Ag, Al, Ni, chromium (Cr), Cu, Au, Pd, Pt, Sn, Ti, W, Rh, Ir, Ru, Mg, Zn, and an alloy thereof. For example, the second electrode 1808b may be formed as an ohmic electrode including an Ag layer deposited with respect to the second conductive semiconductor layer 1806. The Ag-ohmic electrode functions to reflect light. Selectively, a single layer including Ni, titanium (Ti), Pt, or W or a layer of an alloy thereof may be alternately stacked on the Ag layer. In more detail, a Ni/Ti layer, a TiW/Pt layer, or a Ti/W layer may be stacked below the Ag layer or the aforementioned layers may be alternately stacked below the Ag layer.

The first electrode 1808a may be formed in a manner that a Cr layer may be stacked with respect to the first conductive semiconductor layer 1804 and then Au/Pt/Ti layers may be sequentially stacked on the Cr layer, or an Al layer may be stacked with respect to the second conductive semiconductor layer 1806 and then Ti/Ni/Au layers may be sequentially stacked on the Al layer.

In order to improve an ohmic characteristic or a reflective characteristic, the first and second electrodes 1808a and 1808b may be formed of various materials or may have various stacking structures, other than the aforementioned materials and structures.

The insulator 1803 may have an open area to expose a portion of the first and second electrodes 1808a and 1808b, such that the first and second electrode pads 1819a and 1819b may contact the first and second electrodes 1808a and 1808b. The insulator 1803 may be deposited to have a thickness between about 0.01 μm and about 3 μm via SiO₂ and/or SiN CVD processes at a temperature of about 500° C. or less.

The first and second electrodes 1808a and 1808b may be disposed in the same direction and, as will be described below, the first and second electrodes 1808a and 1808b may be mounted in the form of a flip-chip in a lead frame. In this case, the first and second electrodes 1808a and 1808b may be disposed to face in the same direction.

In particular, the first electric power connector 1809a may be formed by the first electrode 1808a having a conductive via that penetrates through the active layer 1805 and the second conductive semiconductor layer 1806 and then is connected to the first conductive semiconductor layer 1804 in the emission stack S.

In order to decrease a contact resistance between the conductive via and the first electric power connector 1809a, a total number, shapes, pitches, a contact area with the first conductive semiconductor layer 1804, or the like of the conductive via and the first electric power connector 1809a may be appropriately adjusted, and since the conductive via and the first electric power connector 1809a are arrayed in rows and columns, a current flow may be improved.

An electrode structure of the other side of the semiconductor light-emitting device 1800 may include the second electrode 1808b that is directly on the second conductive semiconductor layer 1806, and the second electric power connector 1809b that is on the second electrode 1808b. The second electrode 1808b may function to form an electrical ohmic connection with the second electric power connector 1809b and may be formed of a light reflection material, so that, when the LED chip 1810 is mounted as a flip-chip structure, the second electrode 1808b may efficiently discharge light, which is emitted from the active layer 1805, toward the substrate 1801. According to a major light emission direction, the second electrode 1808b may be formed of a light-transmitting conductive material such as transparent conductive oxide.

The aforementioned two electrode structures may be electrically separated from each other by using the insulator 1803. Any material or any object having an electrical insulation property may be used as the insulator 1803. For example, a material having a low light-absorption property may be used according to an exemplary embodiment. In this case, silicon oxide or silicon nitride such as SiO₂, SiOₓN_{y}, SiₓN_{y}, or the like may be used. According to one or more exemplary embodiments, the insulator 1803 may have a light reflection structure in which a light reflective filler is distributed throughout a light transmitting material.

The first and second electrode pads 1819a and 1819b may be connected to the first and second electric power connectors 1809a and 1809b, respectively, and thus may operate as external terminals of the LED chip 1810. For example, the first and second electrode pads 1819a and 1819b may be formed of Au, Ag, Al, Ti, W, Cu, tin (Sn), Ni, Pt, Cr, nickel tin (NiSn), titanium tungsten (TiW), gold tin (AuSn), or an eutectic alloy thereof. In this case, when the first and second electrode pads 1819a and 1819b are mounted on the mounting substrate 1820, the first and second electrode pads 1819a and 1819b may be bonded to the mounting substrate 1820 by using a eutectic metal, so that a separate solder bump that may generally be used in flip-chip bonding may not be used. Compared to a case of using the solder bump, the mounting method using the eutectic metal may achieve a more excellent heat dissipation effect. In this case, in order to obtain the excellent heat dissipation effect, the first and second electrode pads 1819a and 1819b may be formed while having large areas.

Also, a buffer layer may be formed between the emission stack S and the substrate 1801, and in this regard, the buffer layer may be formed as an undoped semiconductor layer including nitride or the like, so that the buffer layer may decrease a lattice defect of an emission structure that is grown on the buffer layer.

The substrate 1801 may have first and second primary surfaces that face each other, and in this regard, a convex-concave structure may be formed on at least one of the first and second primary surfaces. The convex-concave structure that is arranged on one surface of the substrate 1801 may be formed of the same material as the substrate 1801 when, for example, a portion of the substrate 1801 is etched, or may be formed of a different material from the substrate 1801.

As in the present exemplary embodiment, since the convex-concave structure is formed at an interface between the substrate 1801 and the first conductive semiconductor layer 1804, a path of light emitted from the active layer 1805 may vary, such that a rate of light that is absorbed in the semiconductor layer may be decreased and a light-scattering rate may be increased. Thus, the light extraction efficiency may be increased.

In more detail, the convex-concave structure may have a regular shape or an irregular shape. Heterogeneous materials that form the convex-concave structure may include a transparent conductor, a transparent insulator, or a material having excellent reflectivity. In this regard, the transparent insulator may include, but is not limited to, SiO₂, SiNx, Al₂O₃, HfO, titanium dioxide (TiO₂), or ZrO. Furthermore, the transparent conductor may include, but is not limited to, a transparent conducting oxide (TCO) such as indium oxide containing ZnO or an additive including Mg, Ag, Zn, Sc, hafnium (Hf), zirconium (Zr), tellurium (Te), selenium (Se), tantalum (Ta), tungsten (W), niobium Nb, Cu, Si, Ni, cobalt (Co), molybdenum (Mo), Cr, or Sn. Moreover, the reflective material may include, but is not limited to, Ag, Al, or a distributed Bragg reflector (DBR) that is formed of a plurality of layers having different refractive indexes.

The substrate 1801 may be removed from the first conductive semiconductor layer 1804. In order to remove the substrate 1801, a laser lift off (LLO) process using a laser, an etching process, or a grinding process may be performed. After the substrate 1801 is removed, the convex-concave structure may be formed on a top surface of the first conductive semiconductor layer 1804.

As illustrated in FIG. 16, the LED chip 1810 is mounted on the mounting substrate 1820. The mounting substrate 1820 has a structure in which upper and lower electrode layers 1812b and 1812a are formed on a top surface and a bottom surface of a substrate body 1811, respectively, and a via 1813 penetrates through the substrate body 1811 so as to connect the upper and lower electrode layers 1812b and 1812a. The substrate body 1811 may be formed of resin, ceramic, or metal, and the upper and lower electrode layers 1812b and 1812a may be metal layers including Au, Cu, Ag, Al, or the like.

It is understood that a substrate on which the LED chip 1810 is mounted is not limited in one or more other exemplary embodiments to the mounting substrate 1820 of FIG. 16, and any substrate having a wiring structure to drive the LED chip 1810 may be used. For example, it is possible to provide a package structure in which the LED chip 1810 is mounted in a package body having a pair of lead frames.

### LED Chip

### Additional Exemplary Embodiment

An LED chip having one of various structures, other than the aforementioned LED chips, may be used in one or more other exemplary embodiments. For example, it is possible to use an LED chip having a light extraction efficiency that is significantly improved by interacting a quantum well exciton and surface-plasmon polaritons (SPP) formed at an interface between metal and dielectric layers of the LED chip.

<LED Package>

The aforementioned various LED chips may be mounted as bare chips on a circuit board and then may be used in a tubular-type light-emitting apparatus. However, it is understood that one or more other exemplary embodiments are not limited thereto. For example, in one or more other exemplary embodiments, the LED chips may be used in various package structures that are mounted in a package body having a pair of electrodes.

A package including the LED chip (hereinafter referred to as an LED package) according to one or more exemplary embodiments may have an external terminal structure that is easily connected to an external circuit, and a heat dissipation structure for improvement of a heat dissipation characteristic of the LED chip and various optical structures for improvement of a light characteristic of the LED chip. For example, the various optical structures may include at least one of a wavelength converter that converts light emitted from the LED chip into light having a different wavelength, a lens structure for improvement of a light distribution characteristic of the LED chip, etc.

<Example of the LED Package—Chip Scale Package (CSP)>

An example of the LED package that may be used in a tubular-type light-emitting apparatus according to an exemplary embodiment may include an LED chip package having a CSP structure.

The CSP may reduce a size of the LED chip package, may simplify the manufacturing process, and may be appropriate for mass production. In addition, an LED chip, wavelength conversion materials such as phosphors, and an optical structure such as a lens may be integrally manufactured, so that the CSP may be designed as appropriate for the lighting apparatus.

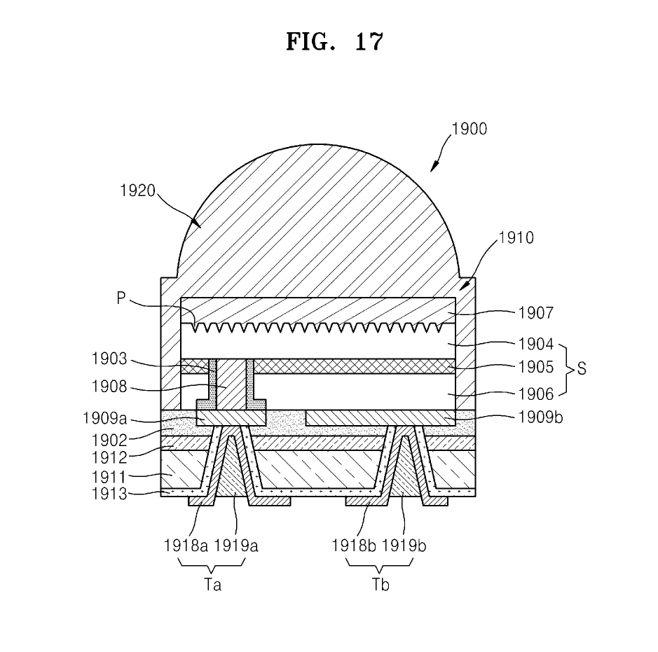

FIG. 17 illustrates an example of a CSP 1900 that has a package structure in which an electrode is formed via a bottom surface of an LED 1910 that is in an opposite direction of a primary light extraction surface, and a phosphor layer 1907 and a lens 1920 are integrally formed, according to an exemplary embodiment.

The CSP 1900 shown in FIG. 17 includes an emission stack S on a mounting substrate 1911, first and second terminals Ta and Tb, the phosphor layer 1907, and the lens 1920.

The emission stack S has a stack structure including first and second conductive semiconductor layers 1904 and 1906, and an active layer 1905 between the first and second conductive semiconductor layers 1904 and 1906. In the present exemplary embodiment, the first and second conductive semiconductor layers 1904 and 1906 may be p-type and n-type semiconductor layers, respectively, and may be formed of a nitride semiconductor such as AlₓIn_{y}Ga_{(1-x-y)}N (0≦x≦1, 0≦y≦1, 0≦x+y≦1). Alternatively, the first and second conductive semiconductor layers 1904 and 1906 may be formed of a GaAs-based semiconductor or a gallium phosphide (GaP)-based semiconductor.

The active layer 1905 that is between the first and second conductive semiconductor layers 1904 and 1906 may emit light that has a predetermined energy due to recombination of electrons and holes and may have a MQW structure in which a quantum well layer and a quantum barrier layer are alternately stacked. The MQW structure may include an InGaN/GaN structure or a AlGaN/GaN structure.

The first and second conductive semiconductor layers 1904 and 1906, and the active layer 1905 may be formed via a semiconductor layer growing process such as MOCVD, molecular beam epitaxy (MBE), hydride vapor phase epitaxial (HVPE), or the like.

In the LED 1910 shown in FIG. 17, a growth substrate is already removed, and a concave-convex structure P may be formed on a surface of the LED 1910 from which the growth substrate is removed. Also, the phosphor layer 1907 may be formed as a light conversion layer on the surface whereon the concave-convex structure P is formed.

The LED 1910 may have first and second electrodes 1909a and 1909b that contact the first and second conductive semiconductor layers 1904 and 1906, respectively. The first electrode 1909a has a conductive via 1908 that contacts the first conductive semiconductor layer 1904 by penetrating through the second conductive semiconductor layer 1906 and the active layer 1905. The conductive via 1908 has an insulating layer 1903 between the active layer 1905 and the second conductive semiconductor layer 1906, thereby preventing a short.

Referring to FIG. 17, one conductive via 1908 is arranged, but in another exemplary embodiment, at least two conductive vias 1908 may be arranged for improved current distribution and may be arrayed in various forms.

The mounting substrate 1911 is a supporting substrate such as a silicon substrate that may be applied to a semiconductor procedure, and various types of substrates may be used as the mounting substrate 1911. The mounting substrate 1911 and the LED 1910 may be bonded to each other via bonding layers 1902 and 1912. The bonding layers 1902 and 1912 may be formed of an electrical insulation material or an electrical conduction material, and in this regard, examples of the electrical insulation material may include oxide such as SiO₂, SiN, or the like, or resin materials including a silicon resin, an epoxy resin, or the like, and examples of the electrical conduction material may include Ag, Al, Ti, W, Cu, Sn, Ni, Pt, Cr, NiSn, TiW, AuSn, or a eutectic metal thereof. The bonding process may be performed in a manner in which the bonding layers 1902 and 1912 are arranged on bonding surfaces of the LED 1910 and the mounting substrate 1911 and then are bonded together.

A via that penetrates through the mounting substrate 1911 is formed at a bottom surface of the mounting substrate 1911 so as to contact the first and second electrodes 1909a and 1909b of the bonded LED 1910. Then, an insulator 1913 may be formed on a side surface of the via and the bottom surface of the mounting substrate 1911. When the mounting substrate 1911 is formed as a silicon substrate, the insulator 1913 may be arranged as a silicon oxide layer that is formed via a thermal oxidation process. By filling the via with a conductive material, the first and second terminals Ta and Tb are connected to the first and second electrodes 1909a and 1909b. The first and second terminals Ta and Tb may include seed layers 1918a and 1918b, and plating chargers 1919a and 1919b that are formed by using the seed layers 1918a and 1918b via a plating process.

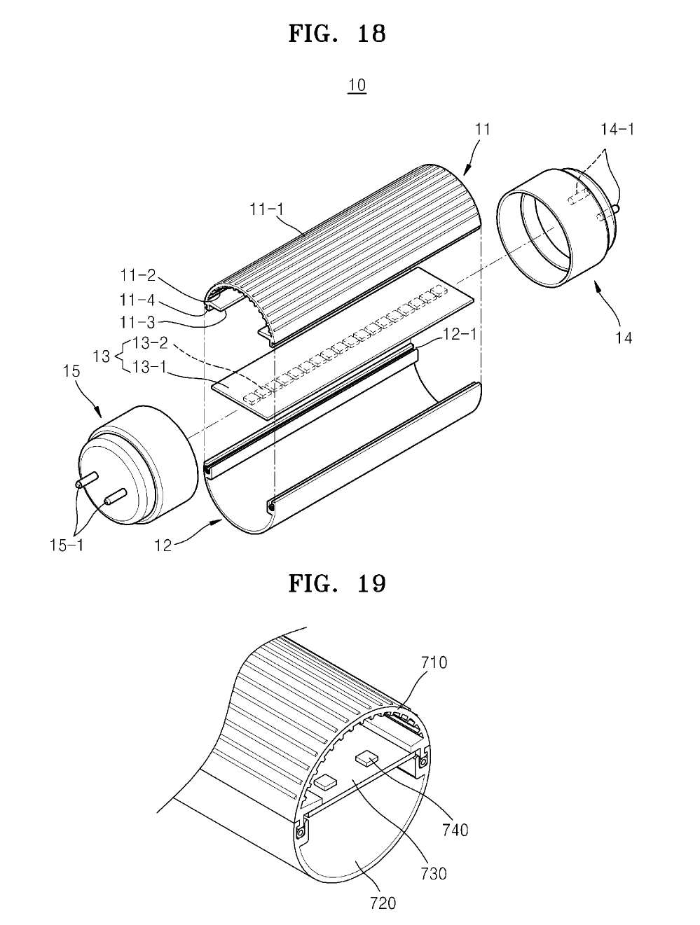

FIG. 18 is an exploded perspective view of a tubular-type light-emitting apparatus 10 according to another exemplary embodiment.

As illustrated in FIG. 18, the tubular-type light-emitting apparatus 10 includes the heat dissipation member 11, the cover 12, the light-emitting module 13, the first socket 14, and the second socket 15.

A plurality of heat dissipation pins 11-1 and 11-2 may be formed in a concave-convex structure on inner and/or outer surfaces of the heat dissipation member 11. In this regard, it is possible to design the heat dissipation pins 11-1 and 11-2 to have various shapes and intervals. A projected supporter 11-3 is formed at the inner side of the heat dissipation member 11. The light-emitting module 13 may be fixed to the supporter 11-3. A projection 11-4 may be at both ends of the heat dissipation member 11.

A projection groove 12-1 may be formed at the cover 12, and the projection 11-4 of the heat dissipation member 11 may be combined with the projection groove 12-1 in a hook-combination manner. Selectively, positions of the projection 11-4 and the projection groove 12-1 may be switched.

The light-emitting module 13 may include the PCB 13-1 and an LED array 13-2. The PCB 13-1 may include circuit wirings to operate the LED array 13-2. Also, circuit configuration elements to operate the LED array 13-2 may be included in the PCB 13-1.

The first socket 14 and the second socket 15 are a pair of sockets and are combined with ends of the cylindrical cover that includes the heat dissipation member 11 and the cover 12.

For example, an electrode terminal 14-1 may be at the first socket 14, and a dummy terminal 15-1 may be at the second socket 15. Also, a dimmer controller may be mounted in one of the first socket 14 and the second socket 15.

In an exemplary embodiment, the dimmer controller may be mounted in the second socket 15 at which the dummy terminal 15-1 is disposed. In another exemplary embodiment, the dimmer controller may be mounted in the first socket 14 at which the electrode terminal 14-1 is disposed. Alternatively, in another exemplary embodiment, the dimmer controller may be mounted in the second socket 15 at which the dummy terminal 15-1 is disposed, and a power supply may be mounted in the first socket 14 at which the electrode terminal 14-1 is disposed.

FIG. 19 illustrates a tubular-type light-emitting apparatus that is applied to an L-tube assembly, according to another exemplary embodiment.

Referring to FIG. 19, the L-tube assembly of the tubular-type light-emitting apparatus includes a cover 710, a heat sink 720, a PCB 730, and an LED package 740.

The cover 710 may be designed to have a serration pattern at an inner surface of the cover 710 so as to improve light distribution.

The heat sink 720 is designed to be combined with the cover 710.

A cylindrical tube formed by combining the heat sink 720 and the cover 710 has a structure capable of having the PCB 730 fixed therein. Furthermore, the LED package 740 is mounted on the PCB 730. For example, the LED package 740 may be disposed in two arrays on the PCB 730.

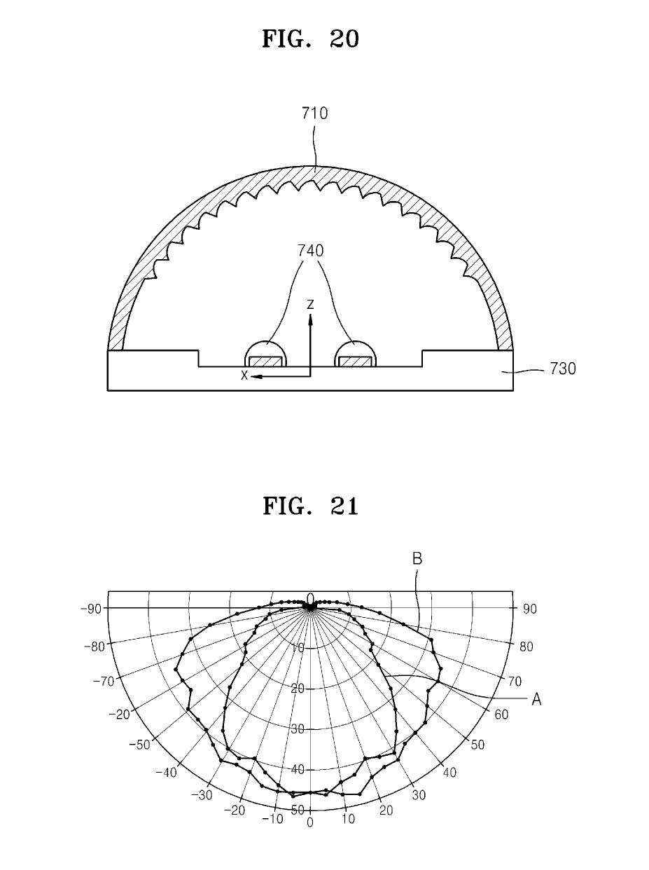

FIG. 20 is a cross-sectional view of parts of the L-tube assembly shown in FIG. 19.

Referring to FIG. 20, the serration pattern is formed on the inner surface of the cover 710 of the L-tube assembly. By forming the serration pattern on the inner surface of the cover 710, a center beam is diffused left and right. Due to the diffusion, a distribution angle may be enlarged to about 90 through 270 degrees. The cover 710 may be formed of a transparent material and may contain a diffuser. Also, an outer surface of the cover 710 may be sanded.

The LED package 740 is disposed in two rows on the PCB 730 that is fixed in the cover 710.

At the L-tube assembly, a reflectance of the heat sink 720 may be about 50%, and a reflectance of the PCB 730 may be about 70%.

An example of light distribution at the L-tube assembly having the aforementioned structure of FIG. 20 is illustrated in FIG. 21.

Referring to FIG. 21, a curved line A of the light distribution indicates light distribution in a lengthwise direction of the L-tube assembly, and a curved line B of the light distribution indicates light distribution in a vertical direction of the tubular cross-section of the L-tube assembly.

Referring to the curved line B of the light distribution shown in FIG. 21, it is possible to see that the light distribution is further diffused left and right.

FIG. 22 is a perspective view of the second socket 15 of the tubular-type light-emitting apparatus 10, according to an exemplary embodiment. FIG. 23 is a block diagram of a configuration of the dimmer controller 15A-2 in the tubular-type light-emitting apparatus 10, according to an exemplary embodiment. Referring to FIG. 22, the dimmer controller 15A-2 is illustrated to be arranged in the second socket 15, although it is understood that one or more other exemplary embodiments are not limited thereto. For example, according to another exemplary embodiment, the dimmer controller 15A-2 may be arranged in the first socket 14.

Referring to FIGS. 22 and 23, the dimmer controller 15A-2 may include a dimmer switch 15A-2a, a signal generator 15A-2b, and a signal transmitter 15A-2c.

The dimmer switch 15A-2a may be configured to be positioned via manipulation at a position that corresponds to a desired intensity of light. Referring to FIG. 22, the dimmer switch 15A-2a is illustrated to rotate along an outer circumferential surface of the second socket 15, although it is understood that one or more other exemplary embodiments are not limited thereto. For example, the dimmer switch 15A-2a may be a rotary switch, a push button, a dial, a sliding member, etc.

The signal generator 15A-2b may generate an electrical signal corresponding to a position of the dimmer switch 15A-2a. For example, the signal generator 15A-2b may be a variable resistor, although it is understood that one or more other exemplary embodiments are not limited thereto.

The signal transmitter 15A-2c may be configured to externally transmit the electrical signal generated by the signal generator 15A-2b. For example, the signal transmitter 15A-2c may indicate wires arranged in the PCB 13-1 (see FIG. 18), although it is understood that one or more other exemplary embodiments are not limited thereto.

FIG. 24 is a circuit diagram of a configuration of the dimmer controller 15A-2 of the tubular-type light-emitting apparatus 10, according to an exemplary embodiment.

Referring to FIG. 24, the dimmer controller 15A-2 may include: a first contact point 71 that is connected to an end of an external circuit; a plurality of second contact points 72 that are arrayed at a predetermined angle interval around the first contact point 71, are electrically inter-connected, and are connected to the other end of the external circuit; and a rotator 73 having an end that is connected to the first contact point 71 and another end that rotates around the first contact point while the other end contacts one of the second contact points 72. Here, the external circuit may be a light-emitting device such as an LED.

When a user manipulates and therefore rotates the dimmer controller 15A-2 while the rotator 73 contacts one of the second contact points 72, the rotator 73 rotates by a unit degree until the rotator 73 contacts the adjacent second contact point 72. The dimmer controller 15A-2 may detect a change in a resistance due to the contact between the rotator 73 and the adjacent second contact point 72, connection and disconnection of a power supply, and other changes in the electrical signal, and then may generate a result of the detection as a dimming signal.

Referring to FIG. 24, the second contact points 72 are illustrated to be discrete with respect to each other. However, it is understood that the second contact points 72 may be configured differently in one or more other exemplary embodiments. For example, the second contact points 72 may be configured according to another exemplary embodiment so that an electrical signal may continuously change, such as a variable resistance.

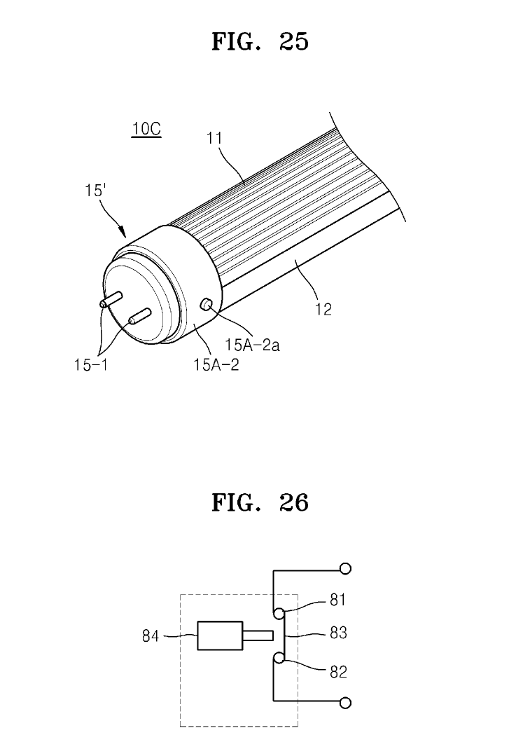

FIG. 25 is a perspective view of a second socket 15′ of a tubular-type light-emitting apparatus 10C, according to another exemplary embodiment. A configuration of a dimmer controller 15A-2 arranged in the second socket 15′ may be the same as or similar to that described with reference to FIG. 23.

Referring to FIGS. 23 and 25, the dimmer controller 15A-2 may include a dimmer switch 15A-2a, a signal generator 15A-2b, and a signal transmitter 15A-2c.

The dimmer switch 15A-2a may be configured to be manipulated at least once so as to achieve desired intensity of light. Referring to FIG. 25, the dimmer switch 15A-2a is pressed in a vertical direction with respect to a surface of the second socket 15′. In another embodiment, the dimmer switch 15A-2a may be configured differently, e.g., to slide in a direction parallel to the surface of the second socket 15′.

According to another example, the dimmer switch 15A-2a may be a push button. In this case, intensity of light may vary every time a user presses the push button. Also, every time the user presses the push button, the intensity of light may stepwise become brighter or dimmed. Furthermore, while the intensity of light varies according to the press of the push button, when the user sequentially presses the push button for a predetermined number of times, the intensity of light may return to its initial intensity of light.

The signal generator 15A-2b may generate an electrical signal that corresponds to the press of the dimmer switch 15A-2a. The signal transmitter 15A-2c is described above with reference to FIG. 23, thus, the detailed descriptions thereof are omitted herein.

FIG. 26 is a circuit diagram of a configuration of a dimmer controller 15A-2 of the tubular-type light-emitting apparatus 10A, according to an embodiment of the inventive concept.

Referring to FIG. 26, the dimmer controller 15A-2 may include: a first contact point 81 that is connected to an end of an external circuit; a second contact point 82 that is connected to the other end of the external circuit; a connector 83 that contacts each of the first contact point 81 and the second contact point 82; a press button 84 that spaces the connector 83 apart from the first contact point 81 and/or the second contact point 82 via press manipulation; and a restorer that controls the connector 83 to contact the first contact point 81 and the second contact point 82 after the press button 84 is manipulated.

When the press button 84 is not pressed, the first contact point 81, the connector 83, and the second contact point 82 are electrically connected so that a power may be supplied to the external circuit. Here, the external circuit may be a light-emitting device such as an LED. When the press button 84 is pressed, the connector 83 is moved by the press button 84, so that the electrical connection among the first contact point 81, the connector 83, and the second contact point 82 is disconnected, and when the press of the press button 84 is released, the electrical connection among the first contact point 81, the connector 83, and the second contact point 82 may be restored by the restorer. The dimmer controller 15A-2 may detect connection or disconnection of the electrical connection due to the manipulation of the press button 84, and therefore may generate a result of the detection as a dimming signal.

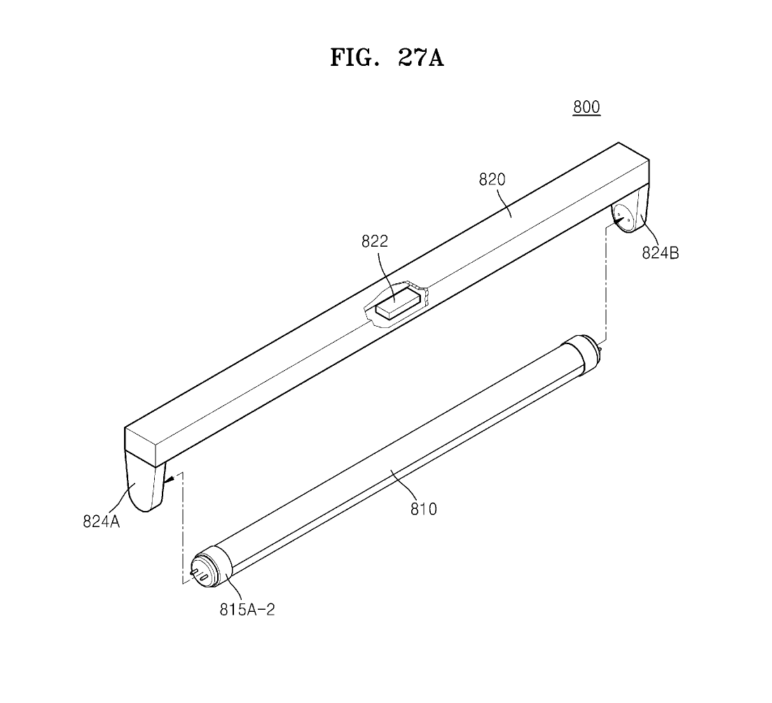

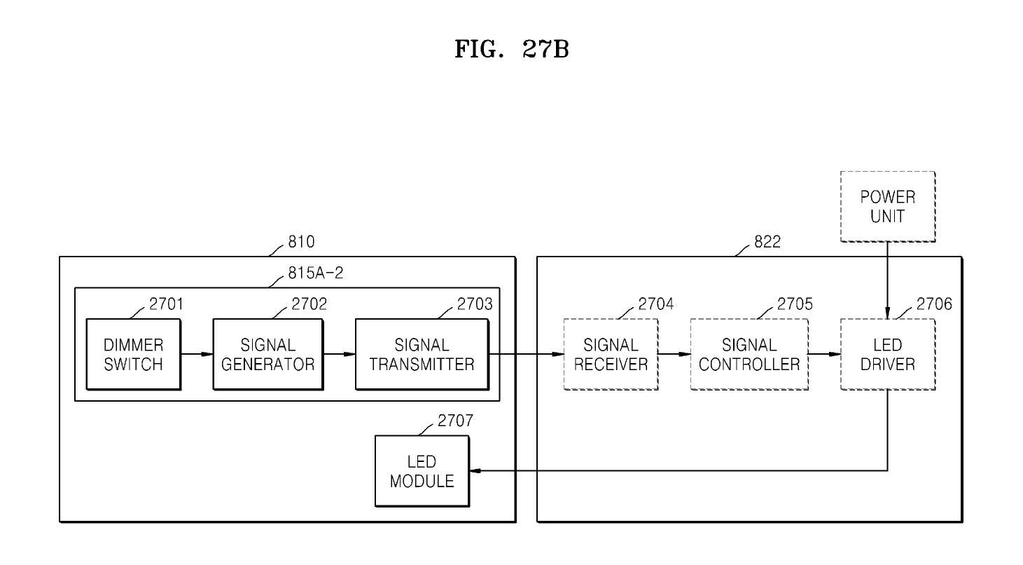

FIG. 27A illustrates a lighting system 800 including a tubular-type light-emitting apparatus 810, according to an exemplary embodiment. FIG. 27B is a block diagram of a configuration of a dimmer controller 815A-2 capable of adjusting intensity of light of the lighting system 800, and an LED module controlled by the dimmer controller 815A-2, according to an exemplary embodiment.

Referring to FIG. 27A, the lighting system 800 may include a body 820, the tubular-type light-emitting apparatus 810, and fixing parts 824A and 824B that are arranged at both ends of the body 820 and that are combined with the tubular-type light-emitting apparatus 810 so as to fix the tubular-type light-emitting apparatus 810. The fixing parts 824A and 824B may have grooves to which terminals of the tubular-type light-emitting apparatus 810 are inserted, although it is understood that one or more other exemplary embodiments are not limited thereto, and any structural configuration may be provided to connect to the tubular-type light-emitting apparatus 810 to the body 820. Also, the fixing parts 824A and 824B may fix the tubular-type light-emitting apparatus 810 in a manner that the tubular-type light-emitting apparatus 810 is longitudinally pressed and then is inserted into the fixing parts 824A and 824B, or in a manner that the tubular-type light-emitting apparatus 810 is inserted into the fixing parts 824A and 824B in a direction perpendicular to a longitudinal direction and then is rotated.

A ballast 822 may be provided in the body 820. The ballast 822 may operate to stably supply power and to control a dimming signal.

Referring to FIGS. 27A and 27B, the dimmer controller 815A-2 in the tubular-type light-emitting apparatus 810 may include a dimmer switch 2701, a signal generator 2702, and a signal transmitter 2703. The dimmer switch 2701 may be enabled for manipulation such as rotation, a vertical press, a horizontal slide, etc., so as to adjust an intensity of light to a desired intensity of light.

The dimmer controller 815A-2 may be arranged in a socket at a side of the tubular-type light-emitting apparatus 810, and the socket including the dimmer controller 815A-2 may be partly exposed between a cover and one of the fixing parts 824A and 824B. The dimmer switch 2701 of the dimmer controller 815A-2 may rotate along an outer circumferential surface of the exposed socket.

The signal generator 2702 may generate an electrical signal that corresponds to manipulation or a position of the dimmer switch 2701. The signal transmitter 2703 may transmit the electrical signal, which is generated by the signal generator 2702, to a signal receiver 2704, and may include wires arranged in a PCB.

The ballast 822 may include a signal receiver 2704, a signal controller 2705, and an LED driver 2706.

The signal receiver 2704 receives the electrical signal transmitted from the signal transmitter 2703, and transfers the electrical signal to the signal controller 2705. The signal controller 2705 may analyze the received electrical signal, and may transmit a control signal corresponding to the received electrical signal to the LED driver 2706. The LED driver 2706 may drive the LED module 2707 according to the control signal.

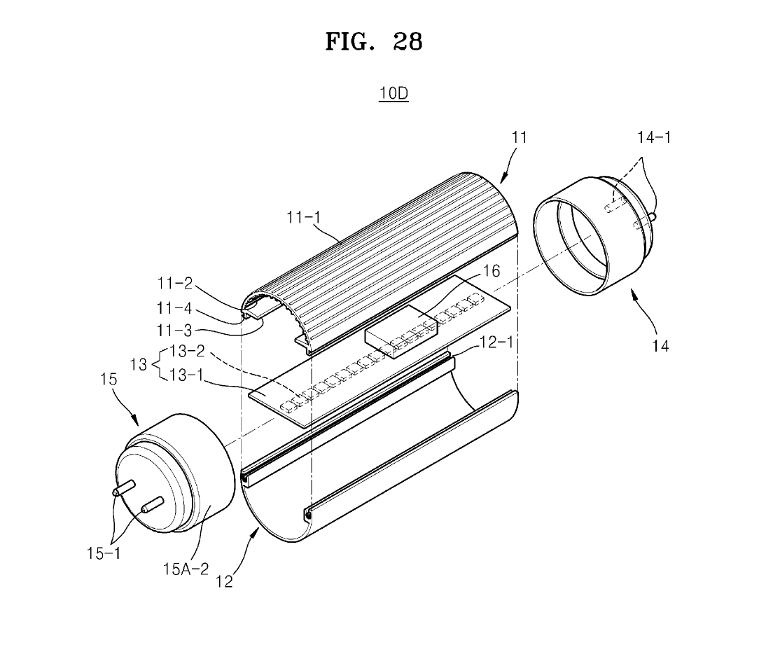

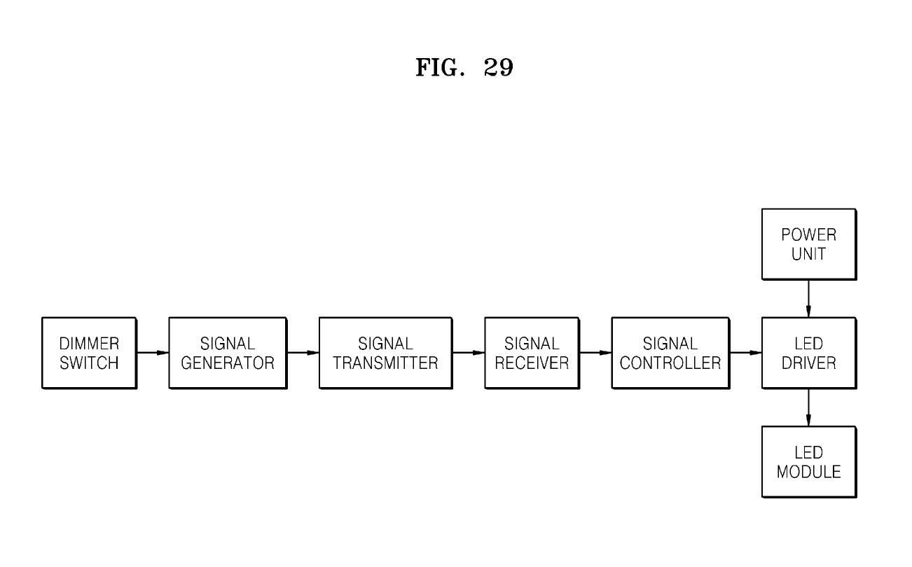

FIG. 28 is an exploded perspective view of a tubular-type light-emitting apparatus 10D according to another exemplary embodiment. FIG. 29 is a block diagram of a configuration of a dimmer controller for adjusting intensity of light of the tubular-type light-emitting apparatus 10D.

Referring to FIGS. 28 and 29, the tubular-type light-emitting apparatus 10D may be the same as or similar to the tubular-type light-emitting apparatus 10 of FIG. 18, except that a ballast 16 is embedded in the tubular-type light-emitting apparatus 10D. This configuration in which the ballast 16 is embedded in the tubular-type light-emitting apparatus 10D is referred to as an integrated light-emitting apparatus.

As described above with reference to FIGS. 27A and 27B, the ballast 16 may include a signal receiver 2904, a signal controller 2905, and an LED driver 2906.

A dimmer switch 2901 may be enabled for manipulation such as rotation, a vertical press, a horizontal slide, etc., so as to adjust an intensity of light to a desired intensity of light. A signal generator 2902 may generate an electrical signal that corresponds to manipulation or a position of the dimmer switch 2901. A signal transmitter 2903 may transmit the electrical signal, which is generated by the signal generator 2902, to the signal receiver, and may include wires arranged in a PCB.

The signal receiver 2904 receives the electrical signal transmitted from the signal transmitter 2903, and transfers the electrical signal to the signal controller 2905. The signal controller 2905 may analyze the received electrical signal, and may transmit a control signal corresponding to the received electrical signal to the LED driver 2906. The LED driver 2906 may drive the LED module 2907 according to the control signal.

Referring to FIGS. 22 through 26, 27A and 27B, 28, and 29, the dimmer controller is arranged in the second socket 15. However, as described above with reference to FIG. 1B, the dimmer controller may be arranged in the first socket 14 in one or more other exemplary embodiments. It is understood by one of ordinary skill in the art that the dimmer controller may be applied to the first socket 14 in one or more other exemplary embodiments, based on the descriptions with reference to FIGS. 22 through 29.

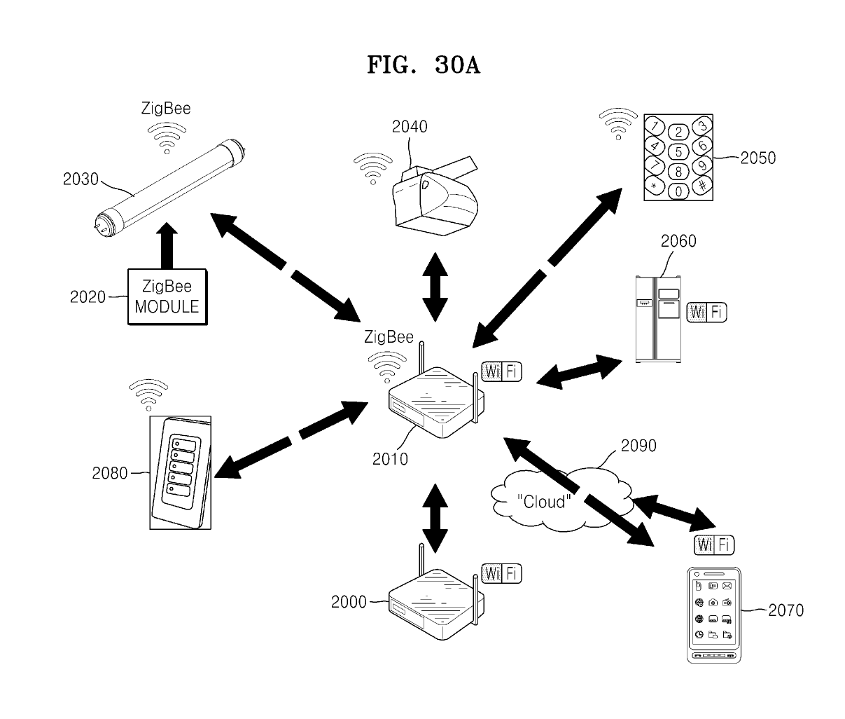

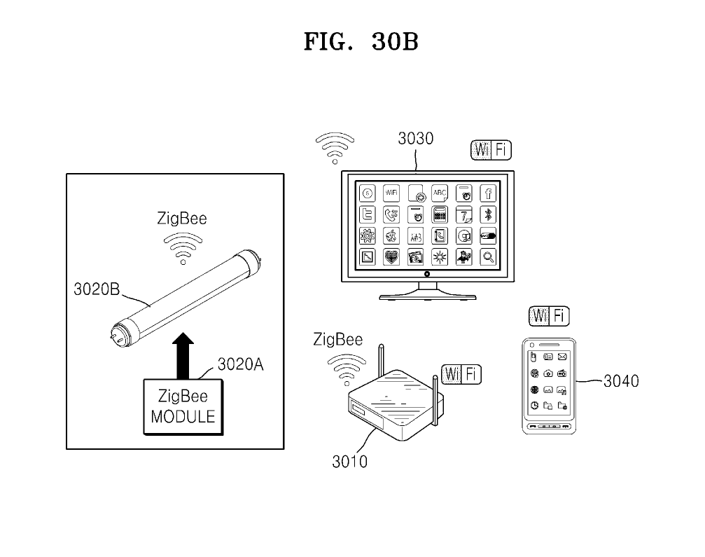

FIGS. 30A and 30B illustrate a home network to which a lighting system using a tubular-type light-emitting apparatus is applied, according to one or more exemplary embodiments.

As illustrated in FIG. 30A, the home network may include a home wireless router 2000, a gateway hub 2010, a ZigBee module 2020, a tubular-type light-emitting apparatus 2030, a garage door lock 2040, a wireless door lock 2050, a home appliance 2060, a cell phone 2070, a wall-mounted switch 2080, and a cloud network 2090.

According to operating statuses of a bedroom, a living room, an entrance, a garage, electric home appliances, or the like and ambient environments/situations, illumination brightness of the tubular-type light-emitting apparatus 2030 may be automatically adjusted by using in-house wireless communication such as ZigBee, Wi-Fi, or the like.

For example, as illustrated in FIG. 30B, according to a type of a program broadcasted on a TV 3030 or brightness of a screen of the TV 3030, illumination brightness of a tubular-type light-emitting apparatus 3020B may be automatically adjusted by using a gateway 3010 and a ZigBee module 3020A. In an exemplary embodiment, when a cozy atmosphere is desired due to broadcasting of a soap opera, illumination may be adjusted to have a color temperature equal to or less than 12000K according to the cozy atmosphere. In another exemplary embodiment, when a light atmosphere is desired due to broadcasting of a comedy program, illumination may be adjusted to have a color temperature equal to or greater than 12000K and may have a blue-based white color. Additionally, according to an exemplary embodiment, the illumination brightness of the tubular-type light-emitting apparatus 3020B may be manually adjusted via a cell phone 3040 through the gateway 3010. Furthermore, according to an exemplary embodiment, various settings for the automatic adjustment of the illumination brightness may be configured via the cell phone 3040.

The ZigBee module 2020 or 3020A may be integrally modularized with a photo sensor, and may be integrally formed with a light-emitting apparatus.

Visible-light wireless communication technology involves wirelessly delivering information by using light having a visible wavelength band that is visible to human eyes. The visible-light wireless communication technology is different from a related art wired optical communication technology and related art infrared wireless communication in that the visible-light wireless communication technology uses light having a visible wavelength band, and is different from the related art wired optical communication technology in that the visible-light wireless communication technology uses a wireless environment. Also, the visible-light wireless communication technology has excellent convenience and physical security in that the visible-light wireless communication technology is not regulated or controlled in terms of a frequency usage, unlike related art radio frequency (RF) wireless communication, is unique since a user may check a communication link, and has a characteristic of a convergence technology by simultaneously allowing for a light source to be used for its original purpose and an additional purpose of a communication function.

Also, LED illumination may be used as inner or outer light sources for vehicles. For the inner light sources, the LED illumination may be used as an inner light, a reading light, a gauge board, or the like for vehicles, and for the outer light sources, the LED illumination may be used as a headlight, a brake light, a direction guide light, a fog light, a daytime running light, or the like for vehicles.

An LED using a particular wavelength may promote a growth of plants, may stabilize human feelings, and may help treatment for a disease. The LED may be applied to a light source that is used in robots or various mechanical equipment. In addition to the LED having low power consumption and a long lifetime, it is possible to embody illumination according to exemplary embodiment in combination with an environmental-friendly renewable energy power system such as a solar cell system, a wind power system, or the like.

While not restricted thereto, at least some components of an exemplary embodiment can be embodied as computer-readable code on a computer-readable recording medium. For example, an exemplary embodiment may provide a method of operating a light-emitting apparatus, and another exemplary embodiment may provide a computer-readable recording medium having recorded thereon a computer program for executing the method of operating the light-emitting apparatus. In this regard, the method of operating the light-emitting apparatus may include generating a signal according to a dimmer switch on a first socket at a first end of a cover, the cover housing a light-emitting diode (LED) of the light-emitting apparatus; adjusting an intensity of light emitted from the LED according to the generated signal. Additionally, the signal may be generated according to an obtained position of the dimmer switch. Additional details of such a method (or other methods according to other exemplary embodiments) may be understood from the above-described exemplary embodiments.

Furthermore, the computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more elements of the above-described apparatuses 100, 200 can include circuitry, a processor, a microprocessor, etc., and may execute a computer program stored in a computer-readable medium.

While exemplary embodiments have been particularly shown and described above, it will be understood that various changes in form and details may be made therein without departing from the spirit and scope of the following claims.

What is claimed is:

1. A light-emitting apparatus comprising:
a light-emitting module comprising a plurality of light-emitting diodes (LEDs);
a cylindrical cover which houses the light-emitting module, and transmits light emitted from the plurality of LEDs;
a first socket at a first end of the cylindrical cover;
a second socket at a second end of the cylindrical cover; and
a dimmer controller mounted at the first socket so as to adjust an intensity of light emitted from the plurality of LEDs.

2. The light-emitting apparatus of claim 1, wherein the dimmer controller comprises:
a dimmer switch;
a signal generator configured to generate a signal according to a position of the dimmer switch; and
a signal transmitter configured to transmit, to outside of the dimmer controller, the signal generated by the signal generator.

3. The light-emitting apparatus of claim 2, wherein the dimmer controller comprises a variable resistor.

4. The light-emitting apparatus of claim 2, wherein the dimmer switch is configured to rotate, to change the position thereof, along an outer circumferential surface of the first socket.

5. The light-emitting apparatus of claim 4, wherein the signal generator generates a first signal in response to the dimmer switch being in a first position, and generates a second signal in response to the dimmer switch being in a second position.

6. The light-emitting apparatus of claim 1, wherein:
the light-emitting module comprises a blue LED and a phosphor having a yellow color, a green color, a red color, or an orange color so as to emit white light through a combination of the blue LED and the phosphor; and
a Color Rendering Index (CRI) of the emitted white light is between a sodium (Na) lamp level and a solar level.

7. The light-emitting apparatus of claim 1, wherein the light-emitting module is configured to emit white light by combining a blue LED and a phosphor having a yellow color, a green color, a red color, or an orange color, wherein the white light has at least two peak wavelengths, and is positioned at a line segment connecting (x, y) coordinates (0.4476, 0.4074), (0.3484, 0.3516), (0.3101, 0.3162), (0.3128, 0.3292), and (0.3333, 0.3333) of a CIE 1931 coordinate system or is positioned in a region that is surrounded by the line segment and a black body radiation spectrum, and wherein a color temperature of the white light is between 2,000K and 20,000K.

8. The light-emitting apparatus of claim 1, wherein the light-emitting module comprises an insulation resin on a metal substrate, circuit patterns in the insulation resin, and an LED chip electrically connected to the circuit patterns.

9. The light-emitting apparatus of claim 8, wherein the LED chip comprises a plurality of nano emission structures on a substrate.

10. The light-emitting apparatus of claim 9, wherein each of the plurality of nano emission structures comprises a first conductive nano core, an active layer on a surface of the first conductive nano core, and a second conductive semiconductor layer on a surface of the active layer.

11. The light-emitting apparatus of claim 2, further comprising:
a signal receiver configured to receive the signal transmitted from the signal transmitter;
a signal controller configured to generate a control signal according to the signal received from the signal transmitter; and
an LED driver configured to drive the light-emitting module according to the generated control signal.

12. The light-emitting apparatus of claim 1, wherein the first socket comprises an electrode terminal.

13. The light-emitting apparatus of claim 1, wherein the first socket comprises a dummy terminal and the second socket comprises an electrode terminal.

14. A lighting system comprising:
a light-emitting apparatus; and
a body comprising a first fixing part at a first end of the body and a second fixing part at a second end of the body, the first fixing part and the second fixing part configured fixing the light-emitting apparatus to the body,
wherein the light-emitting apparatus comprises:
a light-emitting module comprising a plurality of light-emitting diodes (LEDs);
a cylindrical cover which houses the light-emitting module, and transmits light emitted from the plurality of LEDs;
a first socket at a first end of the cylindrical cover;
a second socket at a second end of the cylindrical cover; and
a dimmer controller mounted at the first socket so as to adjust an intensity of the light emitted from the plurality of LEDs.

15. The lighting system of claim 14, further comprising:
a ballast in the body,
wherein the dimmer controller comprises:
a dimmer switch;
a signal generator configured to generate a signal according to a position of the dimmer switch; and
a signal transmitter configured to transmit the signal generated by the signal generator, and
wherein the ballast comprises:
a signal receiver configured to receive the signal transmitted from the signal transmitter;
a signal controller configured to generate a control signal according to the signal received from the signal transmitter; and
an LED driver configured to drive the light-emitting module according to the generated control signal.

16. The lighting system of claim 14, wherein:
the first socket is partly exposed between the cylindrical cover and the first fixing part; and
the first socket and the second socket are configured to adjust the intensity of the emitted light by being rotated in a circumferential direction thereof.

17. A method of operating a light-emitting apparatus, the method comprising:
generating a signal according to a dimmer switch on a first socket at a first end of a cover, the cover housing a light-emitting diode (LED) of the light-emitting apparatus;
adjusting an intensity of light emitted from the LED according to the generated signal.

18. The method of claim 17, wherein the generating the signal comprises:
obtaining a position of the dimmer switch; and
generating the signal according to the obtained position.

19. The method of claim 18, wherein the dimmer switch is configured to rotate, to change the position thereof, along an outer circumferential surface of the first socket.

20. The method of claim 17, wherein:
the cover is a cylindrical cover comprising the first end at which the first socket is located and a second end at which a second socket is located; and
the first socket comprises an electrode socket or a dummy terminal.
